(19) United States
(12) Patent Application Publication
(10) Pub. No.: US 2007/0276540 A1
(43) Pub. Date: Nov. 29, 2007

(54) Robot, radio detection system, radio detection method and recording medium storing radio detection processing program

(76) Inventors: Akinobu Okuda, Osaka (JP); Osamu Mizuno, Osaka (JP); Yoshihiko Matsukawa, Nara (JP)

Correspondence Address: WENDEROTH, LIND & PONACK L.L.P., 2033 K. STREET, NW, SUITE 800, WASHINGTON, DC, 20006, US

(21) Appl. No.: 11/798,418

(22) Filed: May 14, 2007

(30) Foreign Application Priority Data
May 16, 2006 (JP) 2006-136048

(51) Int. Cl. G06F 19/00; G05B 19/00

(52) U.S. Cl. 700/245; 340/5.1

(57) ABSTRACT

A robot is provided with a position setting unit for setting the position information of a destination, a locomotion unit for a movement to the set position, an actuator for driving the locomotion unit to the set position of movement, and a radio detection system for detecting the presence or absence of an unauthorized radio wave based on received radio waves. The radio detection system includes a radio receiver for detecting radio signals at mutually different positions in accordance with position information, a radio signal storage for storing the detected radio signals, a radio signal verifier for detecting the presence or absence of a radio signal having the same characteristics by comparing a detected radio signal and the radio signal stored in the radio signal storage, and an unauthorized radio wave detector for detecting the presence of an unauthorized radio wave when the radio signal having the same characteristics is present.

### BACKGROUND OF THE INVENTION

1. Field of the Invention

The present invention relates to a robot, a radio detection system, a radio detection method and a recording medium storing a radio detection processing program and particularly to a robot, a radio detection system, a radio detection method and a recording medium storing a radio detection processing program which are capable of detecting radio waves emitted from a wireless eavesdropping device or spy camera attached to a mobile apparatus main body.

2. Description of the Background Art

In recent years, mobile robots (hereinafter, “robots”) have been commercialized and have started to widespread among general households. Such robots are so constructed as to autonomously act in accordance with commands from users and surrounding circumstances. Further, these robots are equipped with cameras as a visual function to recognize work spaces and mobile spaces of the robots and people and objects touching or approaching the robots, and a microphone as an audio function to hear surroundings voices and sounds for the realization of communication with people.

Robots remotely controllable by means of radio transmission or the like have recently come into existence. With such robots, it has become possible to secretly film and eavesdrop in houses and offices even from remote places using cameras and microphones equipped in the robots. Accordingly, sufficient consideration has needed to be given lest the privacy of robot users and other people should be infringed or business confidential information and the like should be stolen through secret filming, eavesdropping, etc. by the unauthorized use of these robots.

In view of such a situation, a method has been proposed according to which, while a robot is transmitting image information to a remote control system, a warning in the form of a sound or light is given to the outside, thereby letting people around easily recognize the transmission of the image information to prevent the unauthorized use (see, for example, Japanese Unexamined Patent Publication No. 2002-331482).

According to this method, a warning is given to the outside by means of sounds or the blinking of an LED while the image information from a camera equipped in the robot is transmitted to the remote control system (e.g. personal computer provided with a wireless communication function).

On the other hand, sufficient consideration needs to be given also to a possibility of secretly filming or eavesdropping houses regardless of whether or not the robot is remotely controlled by attaching a wireless eavesdropping device or spy camera to the robot separately from the camera and microphone equipped in the robot. Particularly, presently available eavesdropping devices and spy cameras are small-sized and sophisticated and require no batteries depending on products, and devices that semipermanently keep emitting radio waves for eavesdropping and secret filming unless breaking down once being attached are sold in large quantity.

There have been conventionally proposed various radio detection systems for detecting such wireless eavesdropping devices and spy cameras. An example of such proposed detection systems constantly detects radio waves for eavesdropping and gives a warning upon detecting such a radio wave.

In this radio detection system, electric field intensity data detected in a state free from radio waves for eavesdropping is obtained and stored in an environmental radio wave database at a place where a receiver is installed. A difference in the electric field intensity is detected by comparing the stored electric field intensity data and an electric field intensity data obtained by the receiver, thereby detecting the presence or absence of the radio wave for eavesdropping (see, for example, Japanese Unexamined Patent Publication No. 2003-263692).

However, since the difference in the electric field intensity data is detected at the place where the receiver is installed in the conventional radio detection system, if a robot capable of emitting radio waves and autonomously moving moves in a house, there has been a problem that a main body of the robot itself is erroneously detected as an eavesdropping device or spy camera regardless of whether any eavesdropping device or spy camera is attached to the robot main body and, hence, the presence or absence of the eavesdropping device or spy camera originally desired to be detected cannot be detected.

### SUMMARY OF THE INVENTION

In view of the above problems, an object of the present invention is to provide a robot, a radio detection system, a radio detection method and a recording medium storing a radio detection processing program which are capable of detecting the presence or absence of radio waves emitted from a wireless eavesdropping device or spy camera attached to a mobile apparatus main body.

One aspect of the present invention is directed to a robot, comprising a locomotion unit for movements to a plurality of positions; a radio receiver for receiving radio waves at a plurality of mutually different positions to detect a plurality of radio signals; a radio signal verifier for detecting the presence or absence of a radio signal having the same characteristics by comparing the plurality of detected radio signals; an unauthorized radio wave detector for detecting the presence of an unauthorized radio wave if the radio signal having the same characteristics is present; and a notifier for giving notification when the unauthorized radio wave is detected.

Another aspect of the present invention is directed to a radio detection system, comprising a radio receiver for receiving radio waves at a plurality of mutually different positions to detect a plurality of radio signals; a radio signal verifier for detecting the presence or absence of a radio signal having the same characteristics by comparing the plurality of detected radio signals; and an unauthorized radio wave detector for detecting the presence of an unauthorized radio wave when the radio signal having the same characteristics is present.

Still another aspect of the present invention is directed to a radio detection method, comprising a radio reception step of receiving radio waves at a plurality of mutually different positions to detect a plurality of radio signals; a radio signal verification step of detecting the presence or absence of a radio signal having the same characteristics by comparing the plurality of detected radio signals; and an unauthorized radio wave detection step of detecting the presence of an unauthorized radio wave when the radio signal having the same characteristics is present.

Further another aspect of the present invention is directed to a computer-readable recording medium storing a radio detection processing program, the radio detection processing program causing a computer to function as a radio signal verifier for detecting the presence or absence of a radio signal having the same characteristics by comparing a plurality of radio signals detected at mutually different positions; and an unauthorized radio wave detector for detecting the presence of an unauthorized radio wave when the radio signal having the same characteristics is present.

According to the above constructions, a robot, a radio detection system, a radio detection method and a recording medium storing a radio detection processing program can be provided which can detect the presence or absence of radio waves emitted by a wireless eavesdropping device, spy camera or like device attached to a mobile apparatus main body.

These and other objects, features, aspects and advantages of the present invention will become more apparent upon a reading of the following detailed description and accompanying drawings.

### BRIEF DESCRIPTION OF THE DRAWINGS

FIG. 1 is a block diagram showing the construction of a robot according to a first embodiment of the invention,

FIG. 2 is a flow chart showing the operation of the robot shown in FIG. 1,

FIGS. 3A and 3B are diagrams showing radio states where an unauthorized radio wave is “absent” and “present” in the first embodiment of the invention, respectively,

FIGS. 4A to 4D are graphs showing frequency analysis results in a radio signal verifier in the first embodiment of the invention,

FIG. 5 is a block diagram showing the construction of a robot according to a second embodiment of the invention,

FIG. 6 is a flow chart showing the operation of the robot shown in FIG. 5,

FIG. 7 is a block diagram showing the construction of a robot according to a third embodiment of the invention,

FIG. 8 is a flow chart showing the operation of the robot shown in FIG. 7,

FIG. 9 is a diagram showing a state of detecting an own radio wave in the third embodiment of the invention,

FIGS. 10A and 10B are diagrams showing radio states where an unauthorized radio wave is “absent” and “present” in the third embodiment of the invention, respectively, FIGS. 11A to 11D are graphs showing frequency analysis results in a radio signal verifier in the third embodiment of the invention,

FIG. 12 is a block diagram showing the construction of a robot according to a fourth embodiment of the invention,

FIG. 13 is a block diagram showing the construction of a robot according to a fifth embodiment of the invention,

FIG. 14 is a block diagram showing the construction of a robot according to a sixth embodiment of the invention,

FIG. 15 is a diagram showing an example of an electric field intensity map,

FIG. 16 is a flow chart showing a measuring position selection processing by a measuring position selector in the sixth embodiment of the invention,

FIG. 17 is a block diagram showing the construction of a robot according to a seventh embodiment of the invention, and

FIG. 18 is a block diagram showing the construction of a computer system according to an eighth embodiment of the invention.

### DESCRIPTION OF PREFERRED EMBODIMENTS OF THE INVENTION

Hereinafter, embodiments of the present invention are described with reference to the accompanying drawings.

### First Embodiment

A radio detection system according to a first embodiment of the present invention detects radio signals based on radio waves received at a plurality of mutually different positions (hereinafter, “normal radio waves”), detects the presence or absence of a radio signal having the same characteristics by comparing a plurality of detected radio signals, and outputs a detection result on the presence or absence of a radio signal emitted by a wireless eavesdropping device or spy camera (hereinafter, “unauthorized radio wave”).

Here, the unauthorized radio wave is a radio wave emitted by the wireless eavesdropping device or spy camera attached to a mobile apparatus main body, e.g. a robot, and movable together with the apparatus main body. Since the unauthorized radio wave is detected as a radio signal having the same characteristics, the “presence” of the unauthorized radio wave is judged when the radio wave having the same characteristics is detected. Further, the normal radio signals are radio signals used in usual activities and social activities such as electromagnetic waves from wireless networks, mobile phones, television broadcasting, radio broadcasting, police radio, taxi radio, microwaves and the like.

The radio detection system is so constructed as to notify a certain message to the outside in order to notify the detection of the unauthorized radio wave upon detecting the unauthorized radio wave.

In this way, the robot can discover and notify the attachment of an illegal device for eavesdropping and secret filming to the robot main body by being equipped with the radio detection system and, therefore, can protect the privacy of a robot user.

It should be noted that the radio detection system is not limitedly attached to robots, and may be equipped in devices movable by a remote control such as toys operated by a wireless operation. Alternatively, the radio detection system may be equipped in devices movable by being carried around by people. These devices include, for example, game systems, mobile phones, handheld terminals such as PDA, and notebook personal computers. In any of these apparatuses, similar effects can be fulfilled. The following embodiments of the present invention are described, taking a robot equipped with the radio detection system as an example.

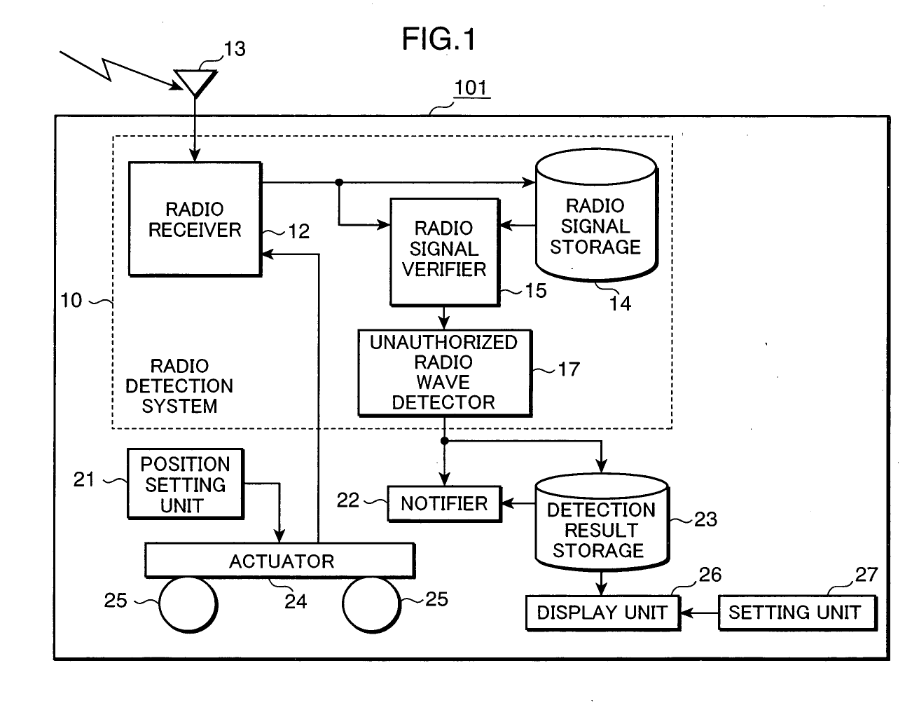

The construction of the robot is described below with reference to FIG. 1. FIG. 1 is a block diagram showing the construction of a robot according to the first embodiment of the present invention.

As shown in FIG. 1, a robot 101 according to the first embodiment of the present invention is provided with a position setting unit 21 for setting the position information of a destination, a locomotion unit 25 for moving the robot 101 to the set position, an actuator 24 for driving the locomotion unit 25 up to the set position of movement, and a radio detection system 10 for detecting the presence or absence of an unauthorized radio wave based on received radio waves.

The robot 101 is also provided with a notifier 22 for giving a warning to the outside in accordance with the detection result of the radio detection system 10, a detection result storage 23 for storing the detection result of the radio detection system 10, a display unit 26 for displaying the stored detection result, and a setting unit 27 for setting display information and the like to be displayed on the display unit 26.

The radio detection system 10 includes a radio receiver 12 for receiving a radio wave to detect a radio signal, a radio signal storage 14 for storing the radio signal, a radio signal verifier 15 for detecting the presence or absence of a radio signal having the same characteristics by comparing a detected radio signal and the stored radio signal, and an unauthorized radio wave detector 17 for determining the presence or absence of an unauthorized radio wave in accordance with the presence or absence of the radio signal having the same characteristics.

The radio receiver 12 includes a detector (not shown) for detecting a radio wave received by an antenna 13, an amplifier (not shown) for amplifying the detected analog radio signal, and an A/D converter (not shown) for converting the amplified analog radio signal into a digital radio signal. With such a construction, the radio receiver 12 detects the radio signal converted into the digital signal from the received radio wave. Further, the radio receiver 12 detects radio signals at mutually different positions based on position information obtained from the actuator 24 to be described later.

The radio signal storage 14 stores the radio signal outputted from the radio receiver 12. A suitable storage device selected from known storage devices including magnetic disk devices such as a hard disk drive (hereinafter, “HDD”) and semiconductor memories can be used as the radio signal storage 14.

The radio signal verifier 15 includes a frequency analyzer (not shown) such as a spectrum analyzer and a comparator (not shown) for comparing spectral intensities. With such a construction, the radio signal verifier 15 obtains a plurality of radio signals detected by the radio receiver 12, e.g. radio signals S1 and S2, analyzes frequency components of the respective signals in the frequency analyzer, and compares the analyzed spectral intensities in the comparator, thereby detecting the presence or absence of the radio signal having the same characteristics. Here, the radio signal verifier 15 performs a verifying operation after receiving the radio signals from the radio receiver 12.

The unauthorized radio wave detector 17 determines the “presence” of the unauthorized radio wave when the “presence” of the radio signal having the same characteristics is detected while determining the “absence” of the unauthorized radio wave when the absence” of the radio signal having the same characteristics is detected, and outputs a corresponding detection result.

The position setting unit 21 outputs the position information of the destination set by the robot 101 to the actuator 24. This position information of the destination is retained in a storage (not shown) of the robot 101 beforehand, and is given by the robot 101 itself upon performing a radio detection. Of course, a position information setting method is not limited to this. For example, a person may transmit the position information of the destination through a wireless communication from the outside of the robot 101 to set the position information.

The actuator 24 includes a pair of a known motor (not shown) such as a DC brushless motor and a known encoder (not shown) such as a potentiometer, and causes the motor to rotate wheels of the locomotion unit 25 in accordance with the position information of the destination outputted from the position setting unit 21. It should be noted that the motor and encoder may be integrally or separately constructed.

The actuator 24 arithmetically processes an output from the encoder to generate the position information. For example, the actuator 24 calculates the position information by odometry, and calculates the position of the robot 101 by adding pulses generated from the encoder attached to a wheel as the wheel rotates if the locomotion unit 25 includes wheels. Thus, the robot 101 can recognize its own position and posture.

The actuator 24 outputs a coincidence signal to the radio receiver 12 when the position information of the destination set in the position setting unit 21 and the detected position information coincide. The radio receiver 12 can detect the radio signal at each coordinate position based on the position information of the destination set in the position setting unit 21 if detecting the radio signal in synchronism with the timing of this coincidence signal.

It should be noted that the position information of the destination set in the position setting unit 21 and the detected position information are judged to coincide if a difference between distances to these positions is smaller than a preset distance difference.

The actuator 24 may store specified position information in a storage (not shown) and output a coincidence signal when this specified position information and the detected position information coincide. The specified position information is, for example, the position information of a living room, a kitchen, a western style room, a Japanese style room, a lavatory or a bathroom if the robot 101 is used at home while being the position information of a conference room, a reference room, an office room or a copy room if the robot 101 is used in a building such as a company. Further, if the robot 101 patrols a specified route or transports luggage in a building such as an apartment house or an airport, the specified position information is a specified position on a patrol route or transport route such as a corridor, an entrance, a common space, a departure lobby and an arrival lobby.

Known wheels, crawlers, legs (two-legged, multilegged) and the like for locomotion may be suitably selected and used as the locomotion unit 25 depending on the purpose. For example, if the locomotion unit 25, for example, climbs up and down the stairs, it is preferable to use legs, e.g. for two-legged locomotion rather than wheels and crawlers. As houses, companies, halls and public facilities have become more and more barrier-free in recent years, differences in level on floors have been reduced. If a range of locomotion is limited to the same floor, sufficient mobility can be obtained even with the wheels. Further, wheeled robots are easier to control as compared to legged robots such as two-legged robots. It is assumed in the following description that the wheels are used as the locomotion unit 25 in the embodiments of the present invention.

The notifier 22 gives notification to the outside based on the detection result outputted from the unauthorized radio wave detector 17. For example, the notifier 22 gives an audio message such as “Unauthorized radio wave was detected. There is a possibility that an eavesdropping device or spy camera is attached to the main body.” if the detection result indicates the “presence” of the unauthorized radio wave. The notifier 22 performs no operation if the detection result indicates the “absence” of the unauthorized radio wave. Instead of the audio notification, a visual notification may be made on the display unit. In this way, a robot user can easily know that the radio detection system 10 has detected the unauthorized radio wave emitted by the eavesdropping device, the spy camera or the like. Further, instead of the audio notification, the above message may be notified to the user utilizing message transmission means such as an email or a telephone. In this way, the robot user at a remote place can easily know that the radio detection system 10 has detected the unauthorized radio wave emitted by the eavesdropping device, the spy camera or the like.

The detection result storage 23 stores the detection result outputted from the unauthorized radio wave detector 17. A suitable storage device selected from known storage devices including magnetic disk devices such as an HDD and semiconductor memories can be used as the detection result storage 23. It is sufficient for the radio signal storage 14 and the detection result storage 23 to be respectively able to store necessary data, and these storages may be realized by separate storage devices or may be realized by dividing a storage area of one storage device.

The display unit 26 displays the detection result stored in the detection result storage 23. The display unit 26 includes a display device such as a liquid crystal panel for the display of warning information in response to the detection result. The setting unit 27 includes a numeric keypad, a keyboard, etc. to input information desired to be displayed in the display unit 26. The robot 101 is also provided with a battery as drive energy, an external sensor for detecting an obstacle, etc. although they are not shown.

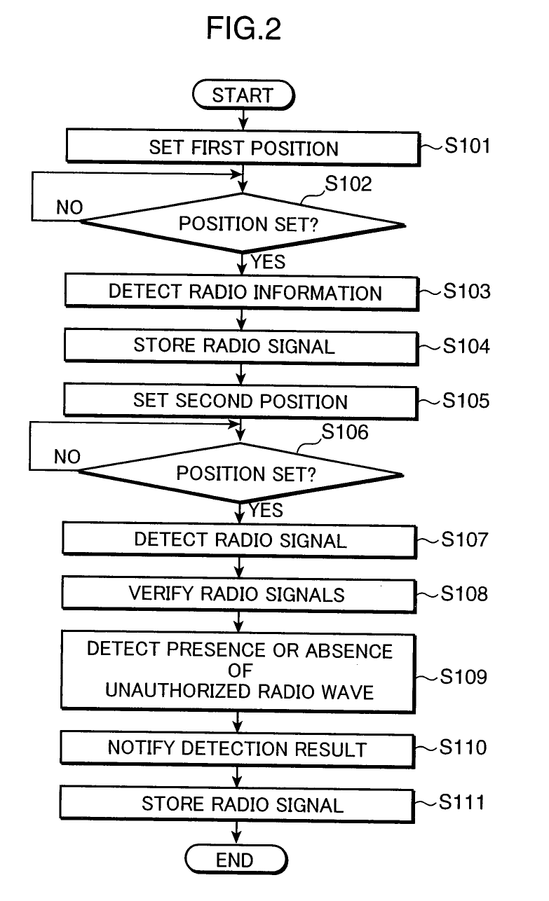

Next, the operation of the robot 101 according to the first embodiment of the present invention is described with reference to FIG. 2. FIG. 2 is a flow chart showing the operation of the robot 101.

In FIG. 2, the robot 101 sets a first position P1 as a destination in the position setting unit 21 in order to detect an unauthorized radio wave (Step S101). Thus, the position setting unit 21 outputs the position information on the set first position P1 to the actuator 24. The actuator 24 rotates the motor of the locomotion unit 25 based on the position information on the first position P1, thereby moving the main body of the robot 101.

Subsequently, the robot 101 moves to the first position P1 and stops there (Step S102). The actuator 24 outputs a coincidence signal to the radio receiver 12 if the detected position information and the position information on the first position P1 coincide. The radio receiver 12 can detect the radio signal at the coordinate position of each destination by detecting the radio signal in synchronism with the timing of this coincidence signal.

Subsequently, the radio receiver 12 of the robot 101 receives a normal radio wave W1 at the first stop position P1 and detects a radio signal S1 (Step S103). Here, the normal radio wave W1 is a normal radio wave received at the first position P1, and the radio signal S1 is a radio signal detected upon receiving the normal radio wave S1 in the radio receiver 12. Subsequently, the radio receiver 12 of the robot 101 stores the radio signal S1 at the first position P1 in the radio signal storage 14 (Step S104).

Subsequently, the robot 101 sets a second position P2 as a destination in the position setting unit 21 upon completing the storage of the radio signal S1 (Step S105). Thus, the position setting unit 21 outputs the position information on the set second position P2 to the actuator 24. The actuator 24 rotates the motor of the locomotion unit 25 based on the position information on the second position P2, thereby moving the main body of the robot 101.

Subsequently, the robot 101 moves to the second position P2 and stops there (Step S106). The actuator 24 outputs a coincidence signal to the radio receiver 12 if the detected position information and the position information on the second position P2 coincide. The radio receiver 12 detects the radio signal in synchronism with the timing of this coincidence signal.

Subsequently, the radio receiver 12 of the robot 101 receives a normal radio wave W2 at the second stop position P2 and detects a radio signal S2. Here, the normal radio wave W2 is a normal radio wave received at the second position P2, and the radio signal S2 is a radio signal detected upon receiving the normal radio wave W2 in the radio receiver 12.

Subsequently, the radio signal verifier 15 of the robot 101 compares the radio signal S1 at the first position P1 stored in the radio wave storage 14 and the detected radio signal S2 at the second position P2, thereby detecting the presence or absence of a radio signal having same characteristics (Step S108).

Subsequently, the unauthorized radio wave detector 17 of the robot 101 determines the “presence” of the unauthorized radio wave if the radio signal verifier 15 detects the “presence” of the radio signal having the same characteristics while determining the “absence” of the unauthorized radio wave if the radio signal verifier 15 detects the “absence” of the radio signal having the same characteristics, and outputs a corresponding detection result (Step S109).

Subsequently, the notifier 22 of the robot 101 gives a warning to the outside in accordance with the detection result (Step S110). For example, the notifier 22 gives an audio message such as “Unauthorized radio wave was detected. There is a possibility that an eavesdropping device or spy camera is attached to the main body.” if the detection result indicates the “presence” of the unauthorized radio wave while performing no operation if the detection result indicates the “absence” of the unauthorized radio wave. Subsequently, the radio receiver 12 stores the radio signal detected at last in the radio signal storage 14 (Step S111).

If one or more radio signals are already stored in the radio signal storage 14, the comparison of a plurality of radio signals is possible if a new radio signal is detected. Thus, operations in Steps S101 to S104 may not be performed. By detecting one radio signal anew, different radio signals can be compared. In order to enable the comparison of new radio signals, the radio signals stored in the radio signal storage 14 may be deleted at once or successively from the oldest one utilizing a timer or a scheduler.

Although the radio signal detected at last is stored in the radio signal storage 14 after the notification of the detection result in the operation of the robot 101, all the radio signals stored in the radio signal storage may be deleted after the notification of the detection result. This enables latest radio signals to be compared every time, and can suppress an amount of data to be stored in the radio signal storage 14.

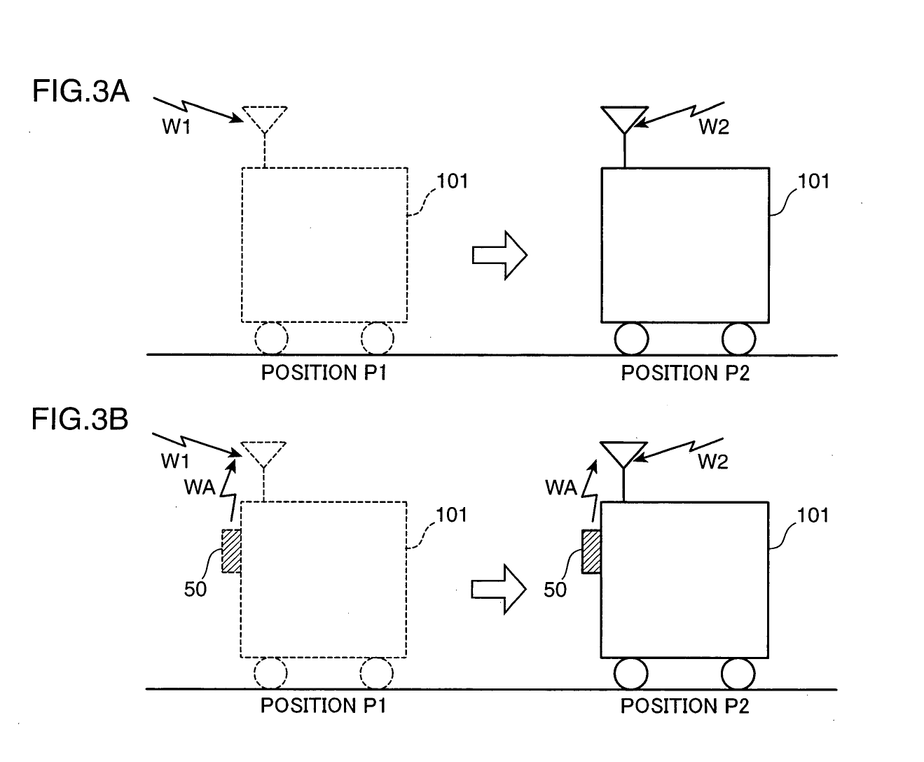

Next, the detection of the unauthorized radio wave is described in detail with reference to FIGS. 3A and 3B. FIGS. 3A and 3B, are diagrams showing radio states where unauthorized radio wave is “absent” and “present”, respectively.

First, the unauthorized radio wave detection in the absence of an unauthorized radio wave is described with reference to FIG. 3A. In FIG. 3A, the robot 101 is assumed to move to the second position P2 and stop there after moving to the first position P1 and stopping there.

The radio receiver 12 receives the normal radio wave W1 by means of the antenna 13 when the robot 101 reaches the first position P1 and detects the radio signal S1. Further, the robot 101 stores the detected radio signal S1 in the radio signal storage 14.

Subsequently, the robot similarly moves to the second position P2 different from the first position P1, receives the normal radio wave W2 at the second position P2, and detects the radio signal S2. Here, the robot 101 detects the presence or absence of the radio signal having the same characteristics by comparing the stored radio signal S1 and the detected radio signal S2. Since there is no unauthorized radio wave in FIG. 3A, the radio signal S1 and the radio signal S2 different from each other are detected at the first position P1 and the second position P2.

Next, the unauthorized radio wave detection when a certain unauthorized device 50 for eavesdropping, secret filming or the like is attached to the main body of the robot 101 to emit an unauthorized radio wave is described with reference to FIG. 3B.

In FIG. 3B, similar to the case of FIG. 3A, the robot 101 is assumed to move to the second position P2 and stop there after moving to the first position P1 and stopping there.

When the robot 101 stops at the first position P1, the radio receiver 12 thereof receives the normal radio wave W1 and an unauthorized radio wave WA emitted by the unauthorized device 50 to detect a radio signal S1a. The radio signal S1a is as follows.

S1a=S1+SA

Here, S1 denotes a radio signal detected upon receiving the normal radio wave W1 and SA denotes a radio signal detected upon receiving the unauthorized radio wave WA.

Subsequently, the robot 101 stores the radio signal S1a in the radio signal storage 14. Subsequently, when the robot 101 stops at the second position P2 different from the first position P1, the radio receiver 12 thereof receives the normal radio wave W2 and the unauthorized radio wave W1 emitted by the unauthorized device 50 to detect a radio signal S2a. The radio signal S2a is as follows.

S2a=S2+SA

Here, S2 denotes a radio signal detected upon receiving the normal radio wave W2 and SA denotes a radio signal detected upon receiving the unauthorized radio wave WA.

Subsequently, the robot 101 can detect the radio signal SA having the same characteristics by comparing the stored radio signal S1a and the detected radio signal S2a. Since the normal radio wave W1 at the first position P1 and the normal radio wave W2 at the second position P2 normally differ as shown in FIG. 3A, the detected radio signals S1a, S2a differ from each other. However, if the unauthorized device 50 emitting the unauthorized radio wave WA is attached to the main body of the robot 101 as shown in FIG. 3B, the radio signal SA having substantially the same intensity and lying substantially in the same frequency band is detected at both first and second positions P1 and P2.

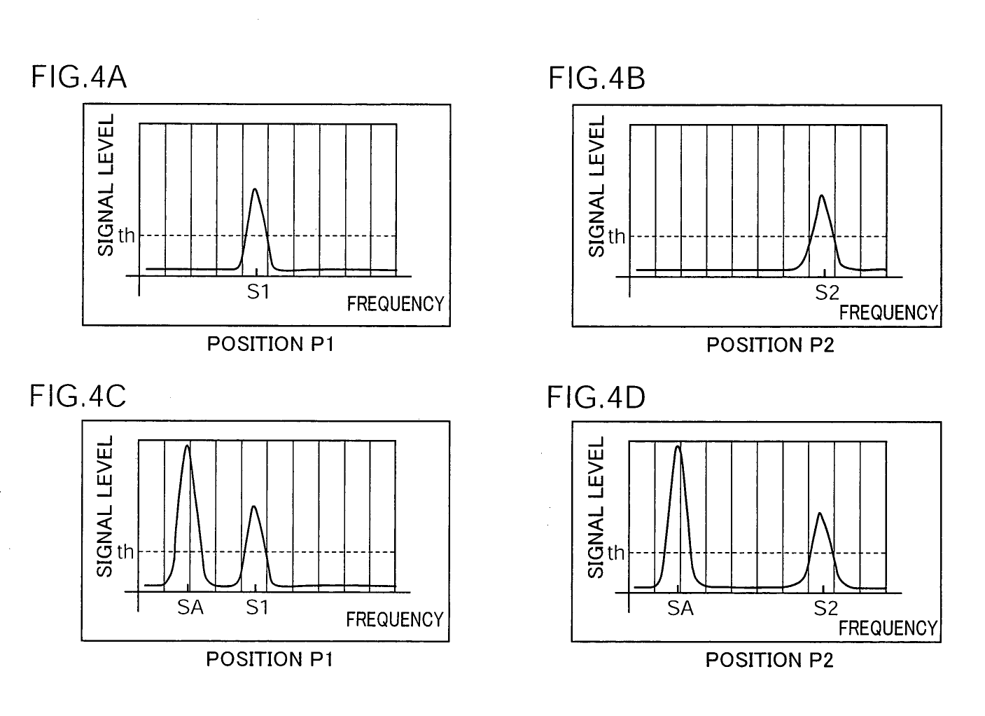

Next, a method for detecting the presence or absence of the radio signal having the same characteristics in the radio signal verifier 15 is described in more detail with reference to FIGS. 4A to 4D. FIGS. 4A and 4B are graphs showing results of the frequency analysis of the radio signals at the first and second positions P1, P2 in FIG. 3A in the radio signal verifier 15, and FIGS. 4C and 4D are graphs similarly showing results of the frequency analysis of the radio signals at the first and second positions P1, P2 in FIG. 3B in the radio signal verifier 15. It should be noted that horizontal axis represents the frequency of the radio signal and vertical axis represents the signal level of the radio signal.

First, detection in the case where there is no radio signal having the same characteristics is described with reference to FIGS. 4A and 4B. The robot 101 first digitalizes the respective signals in the frequency analyzer of the radio signal verifier 15 upon comparing the stored radio signal S1 and the detected radio signal S2.

Specifically, as shown in FIGS. 4A and 4B, a measurement frequency band is divided at equal intervals, and “1” is allocated to the respective divided areas if the signal level is larger than a threshold value th set beforehand, whereas “0” is allocated if the signal level is smaller than the threshold value th, whereby the radio signal is converted into a radio signal matrix. At this time, a radio signal matrix at the first position P1 is (0, 0, 0, 0, 1, 0, 0, 0, 0, 0), and the one at the second position P2 is (0, 0, 0, 0, 0, 0, 0, 1, 0, 0).

Subsequently, logical multiplication (AND) is performed to the corresponding column elements of the radio signal matrices at the first and second positions P1, P2 in the comparator of the radio signal verifier 15. At this time, the “presence” of the radio signal having the same characteristics is detected if there is “1” in at least one of the matrix elements after the processing, whereas the “absence” of the radio signal having the same characteristics is detected if there is “1” in none of the matrix elements. Since the result of the logical multiplication (AND) of the radio signal matrices at the first and second positions P1, P2 is (0, 0, 0, 0, 0, 0, 0, 0, 0, 0) as can be seen from FIGS. 4A and 4B, the “absence” of the radio signal having the same characteristics is detected.

Next, detection in the case where there is a radio signal having the same characteristics is described with reference to FIGS. 4C and 4D. In FIGS. 4C and 4D, the robot 101 similarly first digitalizes the respective signals in the frequency analyzer of the radio signal verifier 15 upon comparing the stored radio signal S1a (=S1+SA) and the detected radio signal S2a (=S2+SA). At this time, a radio signal matrix at the first position P1 is (0, 1, 1, 0, 1, 0, 0, 0, 0, 0), and the one at the second position P2 is (0, 1, 1, 0, 0, 0, 0, 1, 0, 0).

Subsequently, logical multiplication (AND) is similarly performed to the corresponding column elements of the radio signal matrices at the first and second positions P1, P2 in the comparator of the radio signal verifier 15. Here, since the result of the logical multiplication (AND) of the radio signal matrices at the first and second positions P1, P2 is (0, 1, 1, 0, 0, 0, 0, 0, 0, 0) as can be seen from FIGS. 4C and 4D, the “presence” of the radio signal having the same characteristics is detected.

Thus, the robot 101 determines the “presence” of the unauthorized radio wave WA by means of the unauthorized radio wave detector 17 when the “presence” of the radio signal having the same characteristics is detected by the radio signal verifier 15. On the other hand, the robot 101 determines the “absence” of the unauthorized radio wave WA when the “absence” of the radio signal having the same characteristics is detected by the radio signal verifier 15.

In this way, the robot 101 detects the presence or absence of the radio signal having the same characteristic at a plurality of positions of movements, and judges the presence or absence of the unauthorized radio wave WA emitted by the unauthorized device 50 or the like based on this detection result. In order to improve the detection accuracy of the unauthorized radio wave WA, radio waves at additional different positions P3, P4, . . . , Pn may be received and compared if necessary.

As described above, according to the first embodiment of the present invention, the robot 101 detects the radio signals from the radio waves received at the mutually different positions and compares a plurality of detected radio signals, thereby detecting the presence or absence of the radio signal having the same characteristics. Thus, the unauthorized radio wave emitted by the wireless eavesdropping device or spy camera attached to the mobile robot main body and moving together with the robot main body can be detected as the radio signal having the same characteristics.

When the “presence” of the unauthorized radio wave is detected, the robot 101 gives a warning to the outside, assuming that there is a possibility that the unauthorized device 50 is attached to the main body. Thus, the robot user can easily know that the unauthorized radio wave emitted by the wireless eavesdropping device, spy camera or like device has been detected. In this way, the leaks of privacy and corporate secrets can be prevented at the earliest possible time by the discovery and notification of the attachment of the unauthorized device such as an eavesdropping device or spy camera to the robot main body.

It should be noted that the notifier 22 may give a warning by the blinking of a light-emitting diode or the like and similar effects can be fulfilled if measures are taken to enable people around the robot to recognize abnormalities. Since it is sufficient for the radio detection system 10 to receive radio waves at mutually different positions, unauthorized radio waves emitted by an unauthorized device can be similarly detected if not only the robot 101, but also other mobile apparatuses are equipped with the radio detection system 10.

Further, the actuator 24 may correct the position using a plurality of pieces of position information in order to correct a position error occurring due to the slip on the floor with which the wheels and the like are in contact. Further, the position information may be detected using a known visual sensor such as a camera or a sensor such as an ultrasonic sensor. Alternatively, a known global positioning system (hereinafter, “GPS”) may be used.

If radio waves are received at a plurality of different positions, i.e. N points (N is an integer equal to or larger than 3), the detected radio signals are stored together with the respective positions in the radio signal storage 14, and the radio wave having the same characteristics is detected at least at two different points out of the N points, a warning may be given to the outside, assuming that there is a possibility that the unauthorized device 50 is attached to the robot 101 itself. In this case, it is possible to accurately detect the radio waves and give a warning even if radio waves for eavesdropping or secret filming are intermittently emitted. If the transmission of the unauthorized radio wave is detected at least at one point, a state of alert may be entered and this information may be stored in the radio signal storage 14 to be used for the comparison with information at another point. Further, a cycle of intermittent transmission may be measured, and the unauthorized radio wave may be detected by receiving radio waves in synchronism with this cycle. Furthermore, this cycle may be compiled into a database and stored in the radio signal storage 14 to be suitably referred to.

### Second Embodiment

In a second embodiment of the present invention, the detection of radio signals at mutually different positions is made possible by obtaining position information in synchronism with timings of trigger signals generated at specified time intervals and the detection of an unauthorized radio wave is made possible by comparing a plurality of detected radio signals.

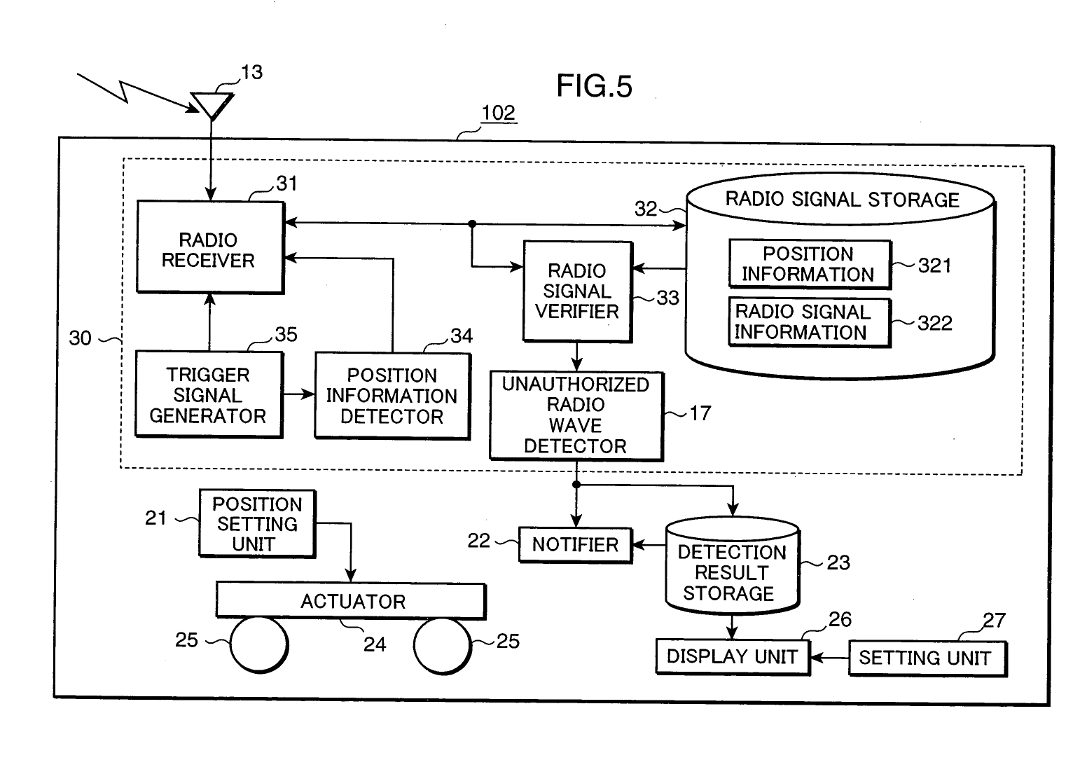

The construction of the second embodiment is described with reference to FIG. 5. FIG. 5 is a block diagram showing the construction of a robot according to the second embodiment of the present invention. Elements similar to those of the first embodiment of the present invention are not described in detail below by being identified by the same reference numerals.

As shown in FIG. 5, a robot 102 of the second embodiment of the present invention differs from the robot 101 of the first embodiment of the present invention in including, in a radio detection system 30, a trigger signal generator 35 for generating trigger signals at specified time intervals and a position information detector 34 for detecting position information in accordance with the trigger signals. Thus, a plurality of pieces of radio signal information and a plurality of pieces of position information are detected at the specified time intervals. It should be noted that the specified time intervals include regular time intervals and irregular time intervals, and various time intervals can be used provided that radio waves can be received at different positions.

The radio detection system 30 includes the position information detector 34 for detecting the present position information of the robot 102, a radio signal storage 32 for storing radio signal information 322 and position information 321, the trigger signal generator 35 for generating trigger signals at the specified time intervals, a radio receiver 31 for receiving a radio wave to detect a radio signal and storing the detected radio signal in the radio signal storage 32 in association with the radio signal information and the position information representing the detected radio signal, a radio signal verifier 33 for detecting the presence or absence of a radio signal having the same characteristics by comparing a plurality of pieces of radio signal information stored in the radio signal storage 32, and an unauthorized radio wave detector 17 for detecting the presence or absence of an unauthorized radio wave in accordance with the presence or absence of the radio signal having the same characteristics.

The radio receiver 31 receives a radio wave to detach a radio signal in synchronism with the generation timing of a trigger signal, and obtains position information from the position information detector 34. The radio receiver 31 stores the detected radio signal and the obtained position information in the radio signal storage 32 while associating them. Here, the radio receiver 31 stores the radio signal information and the position information in the radio signal storage 32 while associating them if a difference between the position information obtained from the position information detector 34 and the position information 321 stored in the radio signal storage 32 is larger than a specified distance difference. Thus, only the radio signal information at the mutually different positions can be stored in the radio signal storage 32 in synchronism with the generation timings of the trigger signals.

The radio signal verifier 33 obtains a plurality of pieces of radio signal information from the radio signal information 322 stored in the radio signal storage 32 in synchronism with the generation timings of the trigger signals (e.g. timings at which the radio receiver 31 stores the radio signal information and the position information in the radio signal storage 32) and compares them. In this way, the presence or absence of a radio signal having the same characteristics can be detected.

The position information detector 34 detects the position information of the main body of the robot 102 in synchronism with the generation timings of the trigger signals. Here, the position information detector 34 detects position information independently of the position information detected by the robot 102 using, for example, a GPS. Thus, the radio detection system 30 can detect the position information even if being attached to an apparatus carried around by a person. It should be noted that a plurality of pieces of position information may be detected to correct the position in order to correct a position error occurred. Alternatively, a known visual sensor such as a camera or a known sensor such as an ultrasonic sensor may be used.

The trigger signal generator 35 can set the specified time intervals to time intervals of, for example, 1 minute, 10 minutes, 60 minutes, 5 hours and 1 day according to needs, and generates trigger signals at the set time intervals.

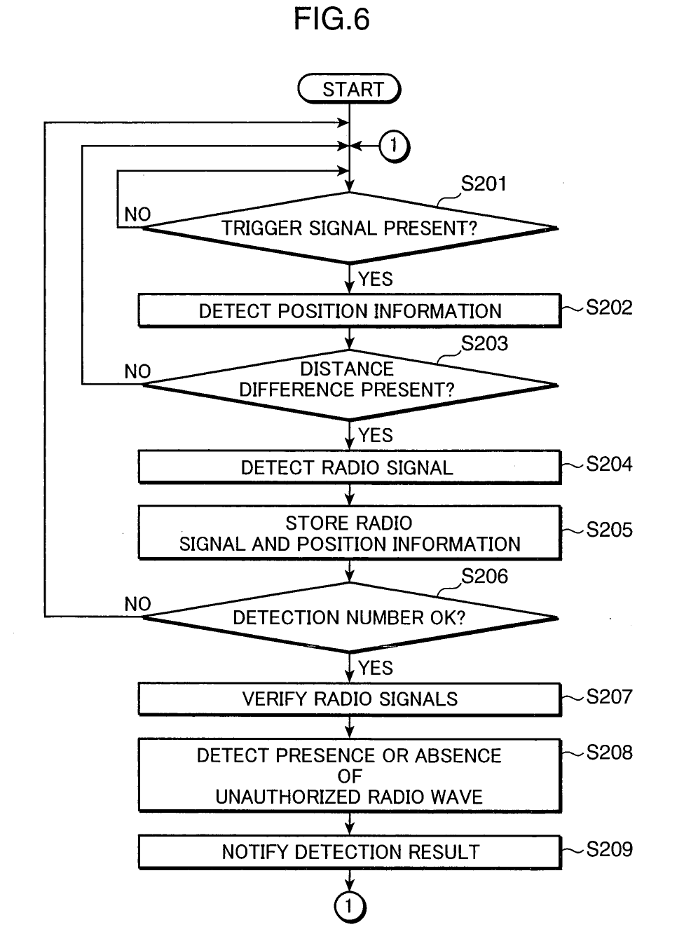

Next, the operation of the robot 102 according to the second embodiment of the present invention is described with reference to FIG. 6. FIG. 6 is a flow chart showing the operation of the robot 102.

In FIG. 6, the radio receiver 31 of the robot 102 waits for the output of a trigger signal from the trigger signal generator 35 (Step S201), and obtains position information from the position information detector 34 in synchronism with the generation of the trigger signal (Step S202).

The radio receiver 31 of the robot 102 compares position information (P2) on a position P2 obtained from the position information detector 34 and position information (P1) on a position P1 stored in the radio signal storage 32 at the generation timing of one previous trigger signal, and determines whether or not a distance between the positions P2 and P1 is larger than a preset distance difference (Step S203). If the difference is larger than the preset distance difference, the radio receiver 31 receives a normal radio wave W2 at the position P2 and detects a radio signal S2 (Step S204).

On the other hand, if the difference is smaller than the preset distance difference by comparing the position information (P2) with the position information (P1) stored in the radio signal storage 32 at the generation timing of one previous trigger signal, this routine returns to Step S201 and the radio receiver 31 waits for the generation of a next trigger signal. This distance difference is an value empirically obtained beforehand, assuming an environment in which the robot 102 is to be used, and is 2 m, 5 m, 10 m, 50 m, 100 m, for example.

The radio receiver 31 of the robot 201 associates radio signal information (S2) representing the radio signal S2 and the position information (P2) on the position P1 and stores them as information (P2, S2) in the radio signal storage 32 (Step S205) after detecting the radio signal S2 in synchronism with the generation of the trigger signal from the trigger signal generator 35. Here, the radio signal storage 32 stores information on the position coordinates in a storage area for the position information 321 and information on the radio signal in a storage area for the radio signal information 322. If there is no position information 321, the radio receiver 31 sets information (P1, S1) stored first as an initial value.

In this way, by means of the radio receiver 31, the robot 102 stores positions P3, P4, . . . , Pn having the preset distance difference from each other and radio signals S3, S4, . . . , Sn detected at the respective positions in the radio signal storage 32 in synchronism with the trigger signals generated by the trigger signal generator 35 while associating them with each other. For example, they are successively stored in the radio signal storage 32 as information (P1, S1), information (P2, S2), information (P3, S3), . . . , information (Pn, Sn). In order to keep the correspondence between the position information on the positions detected in synchronism with the generation of the trigger signals and the radio signal information representing the radio signals detected at these positions, these pieces of information may be associated with each other utilizing timestamps defining a temporal relationship or may be distinguished while being associated with orders of being stored.

As described above, the robot 102 determines whether or not there is the specified distance difference by comparing the position information 321 on the position stored in the radio signal storage 32 at the generation timing of one previous trigger signal and the position information obtained anew, thereby sorting out the radio signal information to be stored anew. Thus, the robot 102 stores only the radio signal information detected at mutually different positions in the radio signal storage 32. For example, if the difference between the position information on the position P1 and the position information on the position P2 falls short of the specified distance difference, no information is stored and the generation of a next trigger signal is waited for. In this way, it is possible to obtain a data string of (P3, S3), . . . , (Pn, Sn) having different pieces of position information while eliminating the information at the same positions.

Subsequently, the radio signal verifier 33 of the robot 102 detects whether or not a plurality of pieces of radio signal information, e.g. a preset detection number of pieces of radio signal information are stored in the radio signal storage 32 (Step S206). The radio signal verifier 33 extracts the plurality of pieces of radio signal information from the radio signal storage 32 if there are the plurality of radio signal information in the radio signal storage 32, and compares the plurality of pieces of extracted radio signal information to detect the presence or absence of a radio signal having the same characteristics (Step S207). For example, the radio signal verifier 33 compares the radio signals S1 and S2 based on the information (P1, S1) and the information (P2, S2). More radio signals may be extracted and compared in order to improve the accuracy of the comparison. For example, the radio signal verifier 33 may compares 5, 10, 20 or 50 extracted radio signals.

On the other hand, the robot 102 returns to Step S201 unless a plurality of pieces of radio signal information are stored in the radio signal storage 32.

Subsequently, the unauthorized radio wave detector 17 of the robot 102 determines the “presence” of an unauthorized radio wave if the radio signal verifier 33 detects the “presence” of the radio signal having the same characteristics while determining the “absence” of the unauthorized radio wave if the “absence” of the radio signal having the same characteristics is detected, and outputs a corresponding detection result (Step S208).

Subsequently, a notifier 22 of the robot 102 gives a warning to the outside in accordance with the detection result (Step S209). Here, a warning is given to the outside when the “presence” of the unauthorized radio wave is detected. Then, the robot 102 returns to Step S201 to wait for a next trigger signal. Thereafter, the operations in steps S201 to S209 are similarly repeated.

As described above, according to the second embodiment of the present invention, the robot 102 can obtain the position information at the specified time intervals, can detect and store the radio signal information at mutually different positions and can detect the presence or absence of the radio signal having the same characteristics by comparing a plurality of pieces of stored radio signal information. Thus, the presence or absence of an unauthorized radio wave emitted by an eavesdropping device, a spy camera or the like moving together with the robot 102 can be detected, and the attachment of the wireless eavesdropping device or spy camera to the robot conducting a wireless communication can be determined based on this detection result.

Since the position information is detected independently of the position information detected by the robot 102 using the position information detector 34 such as a GPS, the radio detection system 30 can detect position information even if being equipped in an apparatus carried around by a person or a mobile apparatus.

It should be noted that the position information and radio signal information stored in the radio signal storage 32 may be deleted regularly, at once or successively from the oldest one utilizing a timer or a scheduler. This enables the comparison of relatively new radio signals and can suppress an amount of data stored in the radio signal storage 32. In the case where more radio signals are extracted and compared in order to improve the accuracy of the comparison, deletion timings may be set according to the number of signals to be extracted.

Further, the radio receiver 31 may store only the position information stored at last in the radio signal storage 32 and similarly compare it with position information obtained anew. This can further reduce the amount of data to be stored in the radio signal storage 32. Furthermore, the position information detector 34 may obtain position information in response to a position information obtaining request from the radio receiver 31 without using trigger signals. In the case where the radio receiver 31 receives the position information from the position information detector 34 in synchronism with the generation timings of the trigger signals, the position information detector 34 may continue to detect the position information.

The position Pn and the radio signal Sn detected at this position may be constantly registered in the radio signal storage 32 while being associated with each other, and a plurality of pieces of radio signal information associated with the different pieces of position information may be compared based on the associated position information when the radio signal verifier 33 compares. In this way, a history of the radio signals at the respective positions can be stored and used as history information later on.

Further, an operation program controlling the generation intervals of trigger signals in the trigger signal generator 35, etc. may be implemented in a central processing unit (hereinafter, “CPU”). When the main body of the robot 102 is not moving, the intervals of trigger signals in the trigger signal generator 35 may be extended or the generation of trigger signals may be stopped.

### Third Embodiment

In a third embodiment of the present invention, a radio wave emitted from a robot main body (hereinafter, “own radio wave”) is detected to reduce the influence of a signal component of the own radio wave on signal components of normal radio waves received at the respective positions of movements.

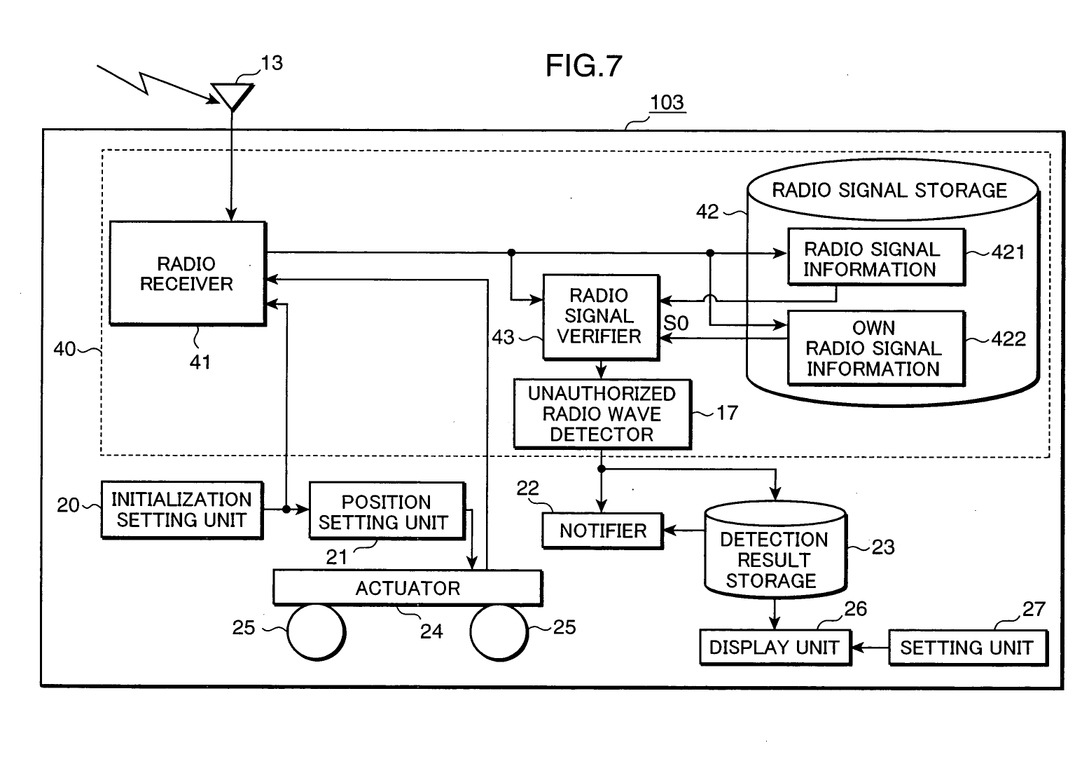

The construction of the third embodiment is described below with reference to FIG. 7. FIG. 7 is a block diagram showing the construction of a robot according to the third embodiment of the present invention. Elements similar to those of the first embodiment of the present invention are not described in detail below by being identified by the same reference numerals.

A robot 103 of the third embodiment of the present invention differs from the robot 101 of the first embodiment of the present invention in that an initialization setting unit 20 for setting an initialization operation is further provided and that a radio detection system 40 includes a radio receiver 41 for receiving an own radio wave emitted from a main body of the robot 103 and detecting a radio signal (hereinafter, “own radio signal”) based on the own radio wave, a radio signal storage 42 for storing radio signal information 421 and own radio signal information 422, and a radio signal verifier 43 for removing the stored own radio signal from a plurality of radio signals and comparing the plurality of radio signals having the own radio signal removed therefrom. Thus, the influence of the own radio wave included in the external normal radio waves received at the respective positions of movements can be reduced, wherefore an unauthorized radio wave can be more accurately detected.

As shown in FIG. 7, the radio detection system 40 includes the radio signal storage 42 for storing the radio signal information 421 and the own radio signal information 422, the radio receiver 41 for detecting radio signals at mutually different positions based on position information detected by an actuator 24, the radio signal verifier 43 for removing the stored own radio signal from a plurality of radio signals stored in the radio signal storage 42 and comparing the plurality of radio signals having the own radio signal removed therefrom to detect the presence or absence of an unauthorized radio wave having the same characteristics, and an unauthorized radio wave detector 17 for determining the presence or absence of the unauthorized radio wave in accordance with the presence or absence of the radio signal having the same characteristics. The radio receiver 41 also stores the detected radio signal and the own radio signal in the radio signal storage 42.

The initialization setting unit 20 causes the robot 103 to perform an initialization operation. Here, an operation of detecting the own radio signal and storing the own radio signal in the main body of the robot 103 is performed as the initialization operation.

The radio receiver 41 receives the own radio wave emitted from the main body of the robot 103 at the time of the initialization to detect the own radio signal. The radio receiver 41 normally receives normal radio waves to detect radio signals. The radio receiver 41 also stores radio signals detected at mutually different positions as the radio signal information 421 in the radio signal storage 42 if a distance difference between these positions is at least a preset distance difference. Further, the radio receiver 41 stores the detected own radio signal as the own radio signal information 422 in the radio signal storage 42 at the time of the initialization.

The radio signal storage 42 stores the radio signal in a storage area for the radio signal information 421 and the own radio signal in a storage area for the own radio signal information 422. A magnetic disk device such as an HDD or a magneto optical disk, a semiconductor memory or a like storage device can be used as the radio signal storage 42. The radio signal verifier 43 detects the presence or absence of a radio signal having the same characteristics by comparing a plurality of radio signals having the stored own radio signal removed therefrom.

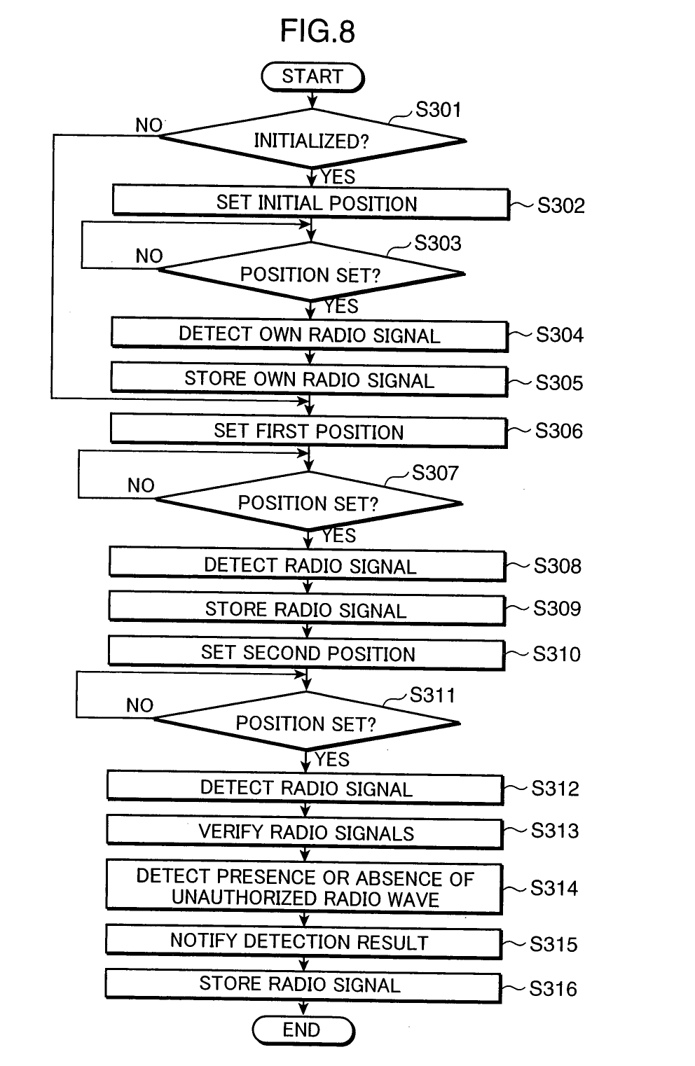

Next, the operation of the robot 103 according to the third embodiment of the present invention is described with reference to FIG. 8. FIG. 8 is a flow chart showing the operation of the robot 103.

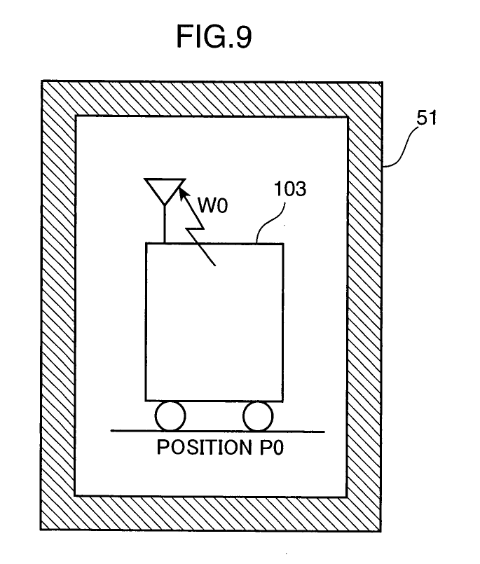

In FIG. 8, upon receiving a request to set an initialization mode (Step S301), the robot 103 causes the initialization setting unit 20 to set a coordinate position P0 (hereinafter, “position P0”) at the time of the initialization in a position setting unit 21 (Step S302). Here, a shielding chamber 51 (see FIG. 9 to be described later) prepared beforehand for the detection of the own radio signal is installed at the position P0. The position setting unit 21 outputs position information on the set position P0 to the actuator 24. The actuator 24 moves the main body of the robot 103 by rotating the wheels of a locomotion unit 25 by means of a motor.

Subsequently, the robot 103 is moved to the position P0 and stopped there by the actuator 24 (Step S303). Then, the radio receiver 41 of the robot 103 receives an own radio wave W0 at the stop position P0 to detect an own radio signal S0 (Step S304). Subsequently, the radio receiver 41 of the robot 103 stores the own radio signal S0 as the own radio signal information 422 in the radio signal storage 42 (Step S305). The robot 103 completes the initialization operation by performing operations in Steps S301 to S305.

Subsequently, the robot 103 detects an unauthorized radio wave and notifies a warning to the outside based on the detection result by operations in Steps S306 to S316.

Specifically, the robot 103 sets a first position P1 as a destination in the position setting unit 21 (Step S306). Thus, the position setting unit 21 outputs position information on the set first position P1 to the actuator 24, which moves the main body of the robot 103 by rotating the wheels of the locomotion unit 25 by means of the motor.

Subsequently, the robot 103 moves to the first position P1 and stops there (Step S307). The actuator 24 outputs a coincidence signal to the radio receiver 41 if the position information on the first position P1 set in the position setting unit 21 and the detected position information coincide. The radio receiver 41 can detect the radio signal at the coordinate position of each destination by detecting the radio signal in synchronism with the timing of this coincidence signal. Here, in the radio receiver 41, S1 denotes a radio signal detected by receiving a normal radio signal W1 and S0 denotes a radio signal detected by receiving the own radio wave W0.

Subsequently, the radio receiver 41 of the robot 103 receives the normal radio wave W1 and the own radio wave W0 at the first stop position P1, and detects a radio signal S1b expressed by the following equation (Step S308).

S1b=S1+S0

Subsequently, the radio receiver 41 of the robot 103 stores the radio signal S1b at the first position P1 in the radio signal storage 42 (Step S309). Then, the robot 103 sets a second position P2 as a next destination in the position setting unit 21 (Step S310) after completing the storage of the radio signal S1b. Thus, the position setting unit 21 outputs position information on the set second position P2 to the actuator 24, which moves the main body of the robot 103 by rotating the wheels of the locomotion unit 25 by means of the motor.

Subsequently, the robot 103 moves to the second position P2 and stops there (Step S311). Then, the radio receiver 41 of the robot 103 receives a normal radio wave W2 at the second stop position P2 and the own radio wave W0 to detect a radio signal S2b expressed by the following equation (Step S312). Here, in the radio receiver 41, S2 denotes a radio signal detected by receiving the normal radio signal W2 and S0 denotes a radio signal detected by receiving the own radio wave W0.

S2b=S2+S0

Subsequently, the radio signal verifier 43 of the robot 103 removes the component of the own radio signal S0 stored at the time of the initialization from the radio signals S1b, S2b stored in the radio signal storage 42 upon comparing the radio signals S1b, S2b. In other words, the radio signal verifier 43 detects the presence or absence of a radio signal having the same characteristics by comparing radio signals S1c, S2c obtained by removing the own radio signal S0 from the radio signals S1b, S2b (Step S313). The radio signals S1c, S2c are expressed as follows.

$$\begin{matrix}S 1 c = S 1 b - S 0 \\ = S 1 + S 0 - S 0 \\ = S 1\end{matrix}$$

$$\begin{matrix}S 2 c = S 2 b - S 0 \\ = S 2 + S 0 - S 0 \\ = S 2\end{matrix}$$

Here, in the radio receiver 41, S1 denotes a radio signal detected by receiving the normal radio signal W1, S2 denotes a radio signal detected by receiving the normal radio wave W2, and S0 denotes a radio signal detected by receiving the own radio wave W0.

In this way, as compared to the first embodiment of the present invention, the radio signal verifier 43 can eliminate the influence of the own radio signal S0 having the same characteristics by removing the component of the own radio signal S0 at the time of the verification, wherefore verification accuracy can be improved.

Subsequently, the unauthorized radio wave detector 17 of the robot 103 determines the “presence” of the unauthorized radio wave if the “presence” of the radio signal having the same characteristics is detected by the radio signal verifier 13 while determining the “absence” of the unauthorized radio wave if the “absence” of the radio signal having the same characteristics is detected, and outputs a corresponding detection result (Step S314).

Subsequently, a notifier 22 of the robot 103 gives a warning to the outside in accordance with the detection result (Step S315). Here, an audio message such as “Unauthorized radio wave was detected. There is a possibility that an eavesdropping device or spy camera is attached to the main body.” is given to the outside if the detection result indicates the “presence” of the unauthorized radio wave while performing no operation if the detection result indicates the “absence” of the unauthorized radio wave. Then, the radio receiver 41 of the robot 103 stores the radio signal S2b in the radio signal storage 42 (Step S316).

As described above, the robot 103 performs the initialization operation by performing the operations in Steps S301 to S305, and detects the unauthorized radio wave and notifies a warning to the outside based on the detection result by performing the operations in Steps S306 to S316.

It should be noted that the initialization setting unit 20 may be omitted if this initialization operation is performed at the time of shipment from a factory and the value of the own radio signal is stored in the main body of the robot 103 beforehand. Further, the initialization operation carried out in Steps S301 to S305 may also be omitted.

In the case where one or more radio signals are stored in the radio signal storage 42, a plurality of radio signals can be compared if one radio signal is detected anew and, therefore, the operations in Steps S306 to S309 may not be performed. By detecting one radio signal anew, a plurality of different radio signals can be compared. Further, the radio signals stored in the radio signal storage 42 may be deleted regularly, at once or successively from the oldest one utilizing a timer or a scheduler so that the comparison can be made between new radio signals.

Although the radio signal detected at last after the notification of the detection result is stored in the radio signal storage 42 in the operation of the robot 103, all the radio signals stored in the radio signal storage 42 may be deleted after the notification of the detection result. This enables latest radio signals to be compared every time, and can suppress an amount of data to be stored in the radio signal storage 42.

Next, a method for detecting the own radio wave emitted by the main body of the robot 103 is described with reference to FIG. 9. FIG. 9 is a diagram showing a state when the own radio wave is detected.

In FIG. 9, the robot 103 moves to the shielding chamber 51 shielding external radio waves, detects the own radio signal emitted from the main body thereof, and stores the own radio signal in the main body thereof as the initialization operation. The shielding chamber 51 is substantially in the form a rectangular parallelepiped made of a steel plate having a specified thickness, and shields radio waves externally incident thereon. The shielding chamber 51 is provided with an automatic door, and the robot 103 can autonomously travel to enter the shielding chamber 51.

Specifically, the robot 103 enters the shielding chamber 51 installed at the position P0 and brings the main body thereof into an operating state as the initialization operation. At this time, the radio receiver 41 receives the own radio wave W0 in a normal operating state that is emitted from the robot 103 itself and detects the own radio signal S0. The radio receiver 41 stores the detected own radio signal S0 as the own radio signal information 422 in the radio signal storage 42 provided in the main body of the robot 103.

It should be noted that the shielding chamber 51 is not particularly limited to the above example. If the robot 103 patrols a specified route or transports luggage in a building such as an apartment house, the shielding chamber 51 may be provided with a recharging function and a superintendent may bring the robot 103 into the shielding chamber 51 to recharge the robot 103 and perform the initialization operation.

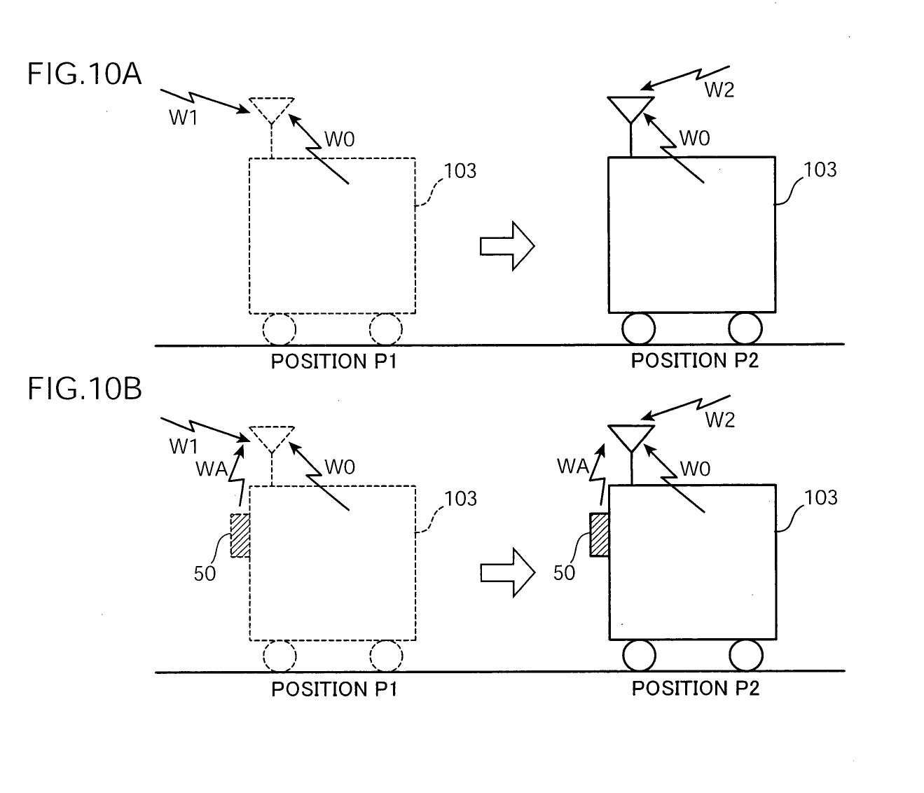

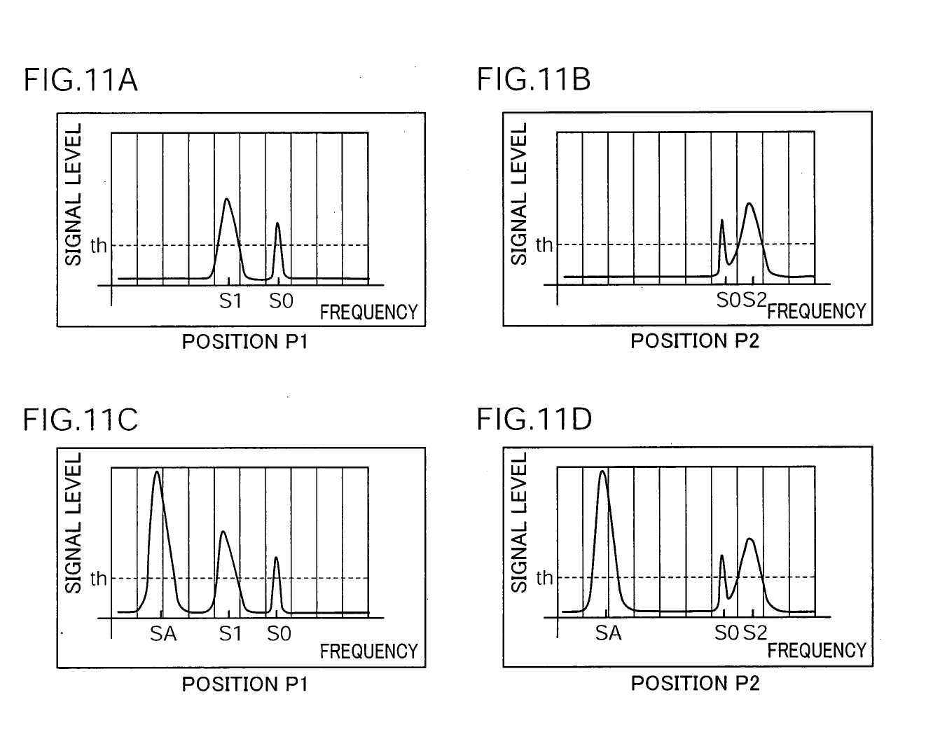

Next, the distinction of a normal radio wave and an unauthorized radio wave is described with reference to FIGS. 10A and 10B. FIG. 10A is a diagram showing a radio state where the unauthorized radio wave is “absent” and FIG. 10B is a diagram showing a radio state where the unauthorized radio wave is “present”.

First, the absence of the unauthorized radio wave is described with reference to FIG. 10A. In FIG. 10A, the robot 103 is assumed to move to the second position P2 and stop there after moving to the first position P1 and stopping there. When the robot 103 moves to the first position and stops there, the radio receiver 41 receives the normal radio wave W1 and the own radio wave W0 to detect the radio signal S1b. S1b is expressed as follows.

S1b=S1+S0

Subsequently, the robot 103 stores the radio signal S1b in the radio signal storage 42. When the robot 103 similarly moves to the second position P2 different from the first position P1 and stops there, the radio receiver 41 receives the normal radio wave W2 and the own radio wave W0 to detect the radio signal S2b. The radio signal S2b is expressed as follows.

S2b=S2+S0

Here, the robot 103 removes the component of the own radio signal S0 stored in the radio signal storage 42 during the initialization operation from the radio signal S1b stored in the radio signal storage 42 and the radio signal S2b when the radio signal verifier 43 compares these radio signals S1b, S2b. In other words, the radio signal verifier 43 compares the radio signals S1c, S2c obtained by subtracting the own radio signal S0 from the radio signals S1b, S2b upon comparing the radio signals S1b, S2b. The radio signals S1c, S2c are expressed as follows.

$$\begin{matrix}S 1 c = S 1 b - S 0 \\ = S 1 + S 0 - S 0 \\ = S 1\end{matrix}$$

$$\begin{matrix}S 2 c = S 2 b - S 0 \\ = S 2 + S 0 - S 0 \\ = S 2\end{matrix}$$

Here, in the radio receiver 41, S1 denotes a radio signal detected by receiving the normal radio signal W1, S2 denotes a radio signal detected by receiving the normal radio wave W2, and S0 denotes a radio signal detected by receiving the own radio wave W0.

In this way, the radio signal verifier 43 can eliminate the influence of the own radio signal S0 having the same characteristics at the time of the verification and can detect the absence of a common signal component.

Next, a state where an unauthorized device 50 such as an eavesdropping device or spy camera is attached to the main body of the robot 103 and an unauthorized radio wave is present is described with reference to FIG. 10B. In FIG. 10B, the robot 103 is assumed to move to the second position P2 and stop there after moving to the first position P1 and stopping there similar to the case of FIG. 10A. At the first position P1, the robot 103 receives the normal radio wave W1, an unauthorized radio wave WA emitted by the unauthorized device 50 and the own radio wave W0 emitted by the robot 103 to detect a radio signal S1d by means of the radio receiver 41. The radio signal S1d is expressed as follows.

S1d=(S1+S0)+SA

Here, in the radio receiver 41, S1 denotes a radio signal detected by receiving the normal radio signal W1, S0 denotes a radio signal detected by receiving the own radio wave W0, and SA denotes a radio signal detected by receiving the unauthorized radio wave WA.

Subsequently, the robot 103 similarly moves to the second position P2 different from the first position P1 and stops there, and receives the normal radio wave W2, the unauthorized radio wave WA emitted by the unauthorized device 50 and the own radio wave W0 emitted by the robot 103 to detect a radio signal S2d. The radio signal S2d is expressed as follows.

S2d=(S2+S0)+SA

Here, in the radio receiver 41, S2 denotes a radio signal detected by receiving the normal radio signal W2, S0 denotes a radio signal detected by receiving the own radio wave W0, and SA denotes a radio signal detected by receiving the unauthorized radio wave WA.

Further, the robot 103 improves accuracy in detecting the radio signal having the same characteristics by comparing the radio signals having the component of the own radio signal S0 stored in the radio signal storage 42 at the time of the initialization removed therefrom. Specifically, the radio signal verifier 43 compares radio signals S1e, S2e obtained by subtracting the own radio signal S0 from the radio signals S1d, S2d upon comparing the detected radio signals S1d, S2d. The radio signals S1e, S2e are expressed as follows.

$$\begin{matrix}S 1 e = ( S 1 + S 0 + SA ) - S 0 \\ = S 1 + SA\end{matrix}$$

$$\begin{matrix}S 2 e = ( S 2 + S 0 + SA ) - S 0 \\ = S 2 + SA\end{matrix}$$

Here, in the radio receiver 41, S1 denotes a radio signal detected by receiving the normal radio signal W1, S2 denotes a radio signal detected by receiving the normal radio signal W2, S0 denotes a radio signal detected by receiving the own radio wave W0, and SA denotes a radio signal detected by receiving the unauthorized radio wave WA.

In this way, the radio signal verifier 43 can eliminate the influence of the component of the own radio signal S0 and can accurately detect the common signal component SA by comparing the radio signals S1e and S2e. The robot 103 determines the presence or absence of the unauthorized radio wave based on the presence or absence of this common signal component SA. As a result, the presence or absence of the unauthorized device 50 attached to the main body can be judged based on the presence or absence of the unauthorized radio wave.

Next, a method for detecting the presence or absence of the radio signal having the same characteristics in the radio signal verifier 43 is described in more detail with reference to FIGS. 11A to 11D. FIGS. 11A and 11B are graphs showing results of the frequency analysis of the radio signals at the first and second positions P1, P2 in FIG. 10A in the radio signal verifier 43, and FIGS. 11C and 11D are graphs similarly showing results of the frequency analysis of the radio signals at the first and second positions P1, P2 in FIG. 10B in the radio signal verifier 43. It should be noted that horizontal axis represents the frequency of the radio signal and vertical axis represents the signal level of the radio signal in FIGS. 11A to 11D.

First, detection in the case where there is no radio signal having the same characteristics is described with reference to FIGS. 11A and 11B. The robot 103 first digitalizes the respective signals in the frequency analyzer of the radio signal verifier 43 upon comparing the stored radio signal S1b (=S1+S0) and the detected radio signal S2b (=S2+S0).

Specifically, a measurement frequency band is divided at equal intervals as shown in FIGS. 11A and 11B, and “1” is allocated to the respective divided areas if the signal level is larger than a threshold value th set beforehand, whereas 101 is allocated if the signal level is smaller than the threshold value th, whereby the radio signal is converted into a radio signal matrix.

Here, the radio signal verifier 43 of the third embodiment of the present invention differs from the radio signal verifier 15 of the first embodiment of the present invention in that the component of the own radio signal S0 stored in the radio signal storage 42 at the time of the initialization operation is removed from the respective radio signals upon converting the radio signals into the radio signal matrix.

In this way, the radio signal matrix at the first position P1 is (0, 0, 0, 0, 1, 0, 0, 0, 0, 0) and the radio signal matrix at the second position P2 is (0, 0, 0, 0, 0, 0, 0, 1, 0, 0). At this point in time, the influence of the own radio signal S0 having the same characteristics is eliminated.

Subsequently, logical multiplication (AND) is performed to the corresponding column elements of the radio signal matrices at the first and second positions P1, P2 in the comparator of the radio signal verifier 43. At this time, the “presence” of the radio signal having the same characteristics is detected if there is “1” in at least one of the matrix elements after the processing, whereas the “absence” of the radio signal having the same characteristics is detected if there is “1” in none of the matrix elements. Since the result of the logical multiplication (AND) of the radio signal matrices at the first and second positions P1, P2 is (0, 0, 0, 0, 0, 0, 0, 0, 0, 0) as can be seen from FIGS. 11A and 11B, the “absence” of the radio signal having the same characteristics is detected.

Next, detection in the case where there is a radio signal having the same characteristics is described with reference to FIGS. 11C and 11D. In FIGS. 11C and 11D, the robot 103 similarly first digitalizes the respective signals in the frequency analyzer of the radio signal verifier 43 upon comparing the stored radio signal S1d (=(S1+S0)+SA) and the detected radio signal S2d (=(S2+S0)+SA).

At this time as well, conversion is carried out after removing the component of the own radio signal S0 stored in the radio signal storage 42 at the time of the initialization operation from the respective radio signals similar to the previous case. As a result, a radio signal matrix at the first position P1 is (0, 1, 1, 0, 1, 0, 0, 0, 0, 0), and the one at the second position P2 is (0, 1, 1, 0, 0, 0, 0, 1, 0, 0). The influence of the own radio signal S0 having the same characteristics is eliminated at this point in time.

Subsequently, logical multiplication is similarly performed to the corresponding column elements of the radio signal matrices at the first and second positions P1, P2 in the comparator of the radio signal verifier 43. Here, the result of the logical multiplication of the radio signal matrices at the first and second positions P1, P2 is (0, 1, 1, 0, 0, 0, 0, 0, 0, 0) as can be seen from FIGS. 11C and 11D, only the radio signal SA having the same characteristics other than the own radio signal S0 is detected and the “presence” of the radio signal having the same characteristics is detected.

As described above, according to the third embodiment of the present invention, the robot 103 receives the own radio signal W0 emitted from the main body thereof, prestores the detected own radio signal S0, and removes the stored radio signal S0 from the detected radio signals at the time of the verification. Thus, the common signal component having the same characteristics can be accurately detected and the presence or absence of the unauthorized radio wave from the eavesdropping device or spy camera can be accurately detected.

Further, by distinguishing the own radio signal emitted from the robot main body and the unauthorized radio wave emitted by the eavesdropping device or spy camera, the unauthorized radio wave can be accurately detected even if the robot has a strong own radio wave. In this way, even the unauthorized radio wave having a frequency approximate to the own radio signal can be accurately detected. It should be noted that the radio signals having the own radio signal S0 removed therefrom may be stored as the radio signal information 421 in the radio signal storage 42.

### Fourth Embodiment

In a fourth embodiment of the present invention, the influence of an own radio signal generated from a robot main body when a robot receives radio information is suppressed by stopping functions included in the respective blocks.

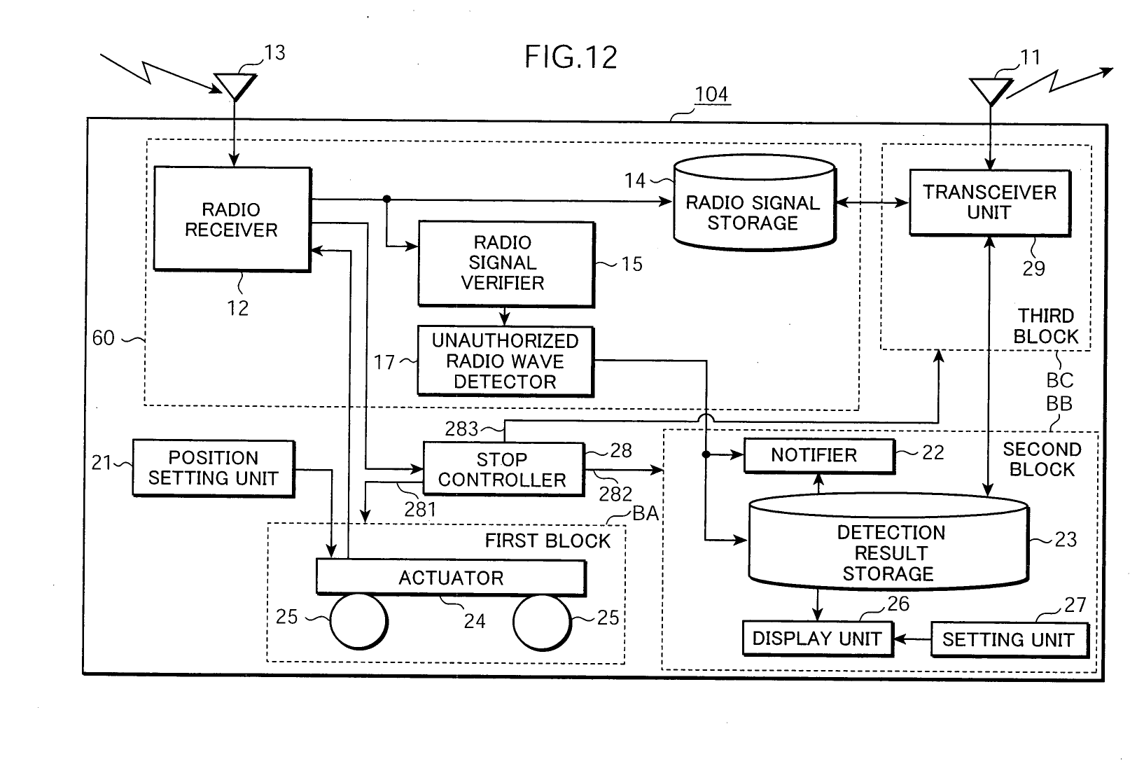

The construction of the fourth embodiment is described below with reference to FIG. 12. FIG. 12 is a block diagram showing the construction of a robot according to the fourth embodiment of the present invention. Elements similar to those of the first embodiment of the present invention are not described in detail below by being identified by the same reference numerals.

A robot 104 of the fourth embodiment of the present invention differs from the robot 101 of the first embodiment of the present invention in including, in a radio detection system 60, a stop controller 28 for causing functions included in specified blocks to be stopped while a radio receiver 12 is detecting a radio signal, thereby suppressing an own radio wave emitted from a main body of the robot 104, and a transceiver unit 29. Thus, the influence of the own radio wave emitted from the main body of the robot 104 and included in normal radio waves when radio signals are detected at the respective positions of movements is reduced to improve accuracy in detecting an unauthorized radio wave.

The stop controller 28 controls as to whether or not to stop the functions included in a first block BA, a second block BB and a third block BC block by block. Thus, the generation of radio waves can be suppressed. Here, an actuator 24 and a locomotion unit 25 are included in the first block BA. A notifier 22, a detection result storage 23, a display unit 26 and a setting unit 27 are included in the second block BB. The transceiver unit 29 is included in the third block BC.

The transceiver unit 29 has a function of transmitting and receiving information stored in a radio signal storage 14 and the detection result storage 23 and external control information for the robot via a transmission antenna 11. It should be noted that contents to be transmitted and received include, for example, the operating state of the robot 104, history information of detection results, stored radio signal information, instruction commands from external apparatuses.

Next, the operation of the robot 104 is described. The robot 104 receives surrounding radio waves at a first stop position P1 and a second position P2 different from the first position P1, and determines the presence or absence of an unauthorized device. First, the robot 104 stops the functions included in the second block BB and third block BC, which are not used at this point in time, at the first stop position P1 in response to control signals 282, 283 from the stop controller 28. Thus, the transceiver unit 29 included in the third block BC is first stopped to stop the transmission of radio waves to the outside. The functions included in the second block BB are also stopped to reduce radio noise. If necessary, the actuator 24 and the locomotion unit 25 included in the first block BA may be stopped in response to a control signal 281. This further reduces radio noise.

The robot 104 can suppress the influence of the radio noise caused by the own radio wave if a radio signal S1 is detected by the radio receiver 12 after the second and third blocks BB, BC are stopped by the stop controller 28. Since the radio receiver 12 and the radio signal storage 14 are in an active state without being included in the second and third blocks BB, BC, there is no hindrance to the reception of a normal radio wave W1 and the detection and storage of a radio signal S1 at the first position P1.

Subsequently, the robot 104 moves to the second position P2 and stops there after the radio signal S1 is stored in the radio signal storage 14. At the second stop position P2, the robot 104 stops the second and third blocks BB, BC in response to the control signals 282, 283 from the stop controller 28, and the radio receiver 12 detects a radio signal S2. The radio receiver 12 of the robot 104 receives a normal radio wave W2 at the second position P2 and stores a detected radio signal S2 in the radio signal storage 14.

The robot 104 makes the second block BB active in response to the control signal 282 of the stop controller 28 after the storage of the radio signal S2 is completed. Further, the robot 104 compares the radio signals S1, S2 stored in the radio signal storage 14 by means of a radio signal verifier 15. An unauthorized radio wave detector 17 detects the presence or absence of a signal having the same characteristics based on the verification result of the radio signal verifier 15 to detect the presence or absence of an unauthorized radio wave, and stores the detection result in the detection result storage 23. The notifier 22 gives a warning to the outside when the unauthorized radio wave is “present”. It should be noted that the stop controller 28 may make the third block BC active by means of the control signal 283 so that data in the detection result storage 23 are transmitted to the outside by the transceiver unit 29.

In this way, the robot 104 can accurately detect the unauthorized radio wave emitted by the unauthorized device by suppressing the own radio wave generated from the inside of the robot main body while the radio signals S1, S2 are being detected.

Although the functions are stopped block by block, each function of performing a specified processing may be independently stopped. For example, only the notifier 22 or only the detection result storage 23 may be stopped. Various changes can be made. If only the transceiver unit 29 is the main cause of the radio noise and it is sufficient to reduce only this radio noise, only the transceiver unit 29 may be stopped. In this way, the radio signals S1 and S2 can be detected with noise components reduced by making the units, which will become the main cause of the radio noise, inactive.

If the robot 104 moves and stops in a flat place, it might not be necessary to constantly perform a positioning control by means of the actuator 24 or the like. In such a case, the power of the actuator 24 may be stopped only while a radio signal is being detected. This can further suppress the generation of radio waves from the inside of the robot main body and improve accuracy in detecting the unauthorized radio wave.

As described above, according to the fourth embodiment of the present invention, the robot 104 suppresses the own radio wave generated by the inside of the main body thereof by stopping the specified functions while the radio signal is being detected Therefore, the unauthorized radio wave emitted by the eavesdropping device, spy camera or like device can be accurately detected.

### Fifth Embodiment

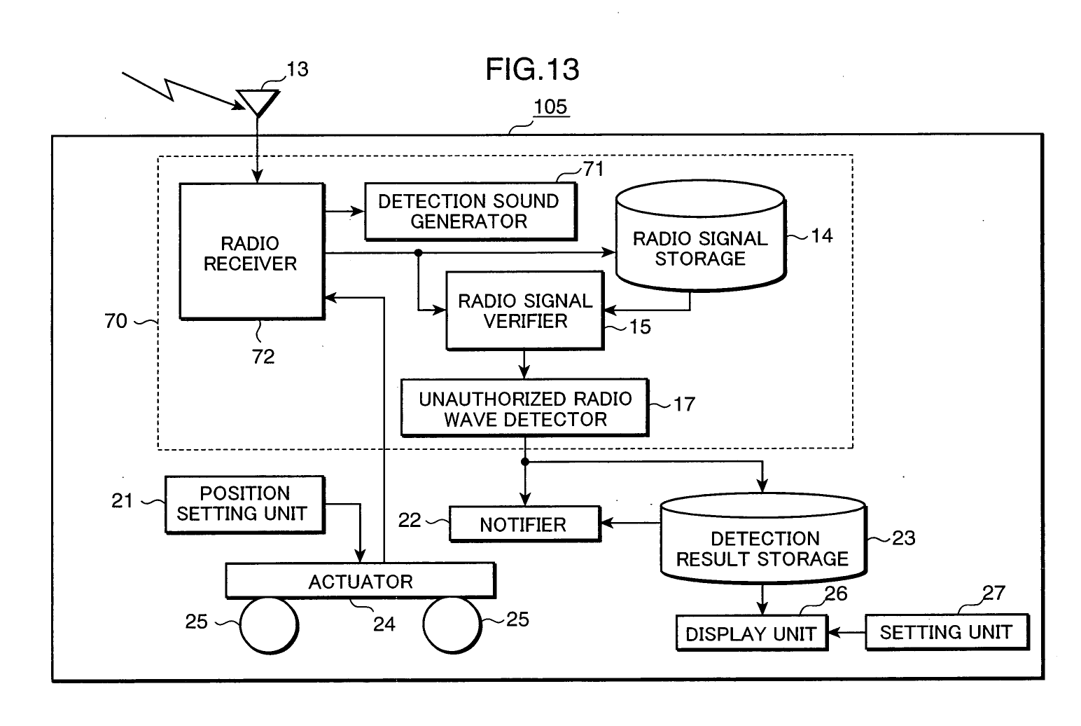

In a fifth embodiment of the present invention, the case of detecting an eavesdropping device or spy camera operative by sound sensing is described. The construction of the fifth embodiment is described below with reference to FIG. 13. FIG. 13 is a block diagram showing the construction of a robot according to the fifth embodiment of the present invention. Elements similar to those of the first embodiment of the present invention are not described in detail below by being identified by the same reference numerals.

As shown in FIG. 13, a robot 105 of the fifth embodiment of the present invention differs from the robot 101 of the first embodiment of the present invention in that, in a radio detection system 70, a radio receiver 72 generates a trigger signal upon detecting a radio signal and a detection sound generator 71 is provided to generate a detection sound in accordance with the trigger signal. In this way, an eavesdropping device or spy camera operative by sound sensing is caused to operate by generating a sound while a radio signal is being detected, whereby an unauthorized radio wave generated by the eavesdropping device or spy camera can be detected.

The radio receiver 72 detects a radio signal in synchronism with the timing of a coincidence signal outputted from an actuator 24 similar to the first embodiment. Further, the radio receiver 72 outputs a trigger signal to the detection sound generator 71 in accordance with the coincidence signal. The detection sound generator 71 drives a loudspeaker or the like to generate a set sound in accordance with the trigger signal from the radio receiver 72. Thus, the detection sound generator 71 can cause the eavesdropping device or spy camera, which emits an unauthorized radio wave, to operate by sound sensing.

Next, the operation of the robot 105 is described. The robot 105 is assumed to move to a second position P2 and stop there after moving to a first position P1 and stopping there. The robot 105 causes the detection sound generator 71 to generate a detection sound while radio signals are being detected at the respective stop positions, thereby detecting an unauthorized radio wave emitted by the sound sensing type unauthorized device.

The robot 105 first moves to the first position P1 and stops there, where a trigger signal is outputted from the radio receiver 72 to the detection sound generator 71 in synchronism with the timing of a coincidence signal outputted from the actuator 24 and a detection sound is generated from the loudspeaker provided in the detection sound generator 71.

Subsequently, the robot 105 detects a radio signal S1 at the stop position P1 by means of the radio receiver 72. Then, the robot 105 stores the detected radio signal S1 in a radio signal storage 14. The robot 105 stops generating the detection sound by means of the detection sound generator 71 after storing the radio signal S1.

Subsequently, the robot 105 moves to the second position P2 different from the first position P1 and stops there, where a trigger signal is similarly outputted from the radio receiver 72 to the detection sound generator 71 in synchronism with a coincidence signal outputted from the actuator 24 and a detection sound is generated from the loudspeaker provided in the detection sound generator 71. Then, the robot 105 detects a radio signal S2 at the second stop position P2 by means of the radio receiver 72.

Subsequently, the robot 105 detects the presence or absence of a signal having the same characteristics by means of a radio signal verifier 15 by comparing the radio signal S1 stored in the radio signal storage 14 and the radio signal S2 detected by the radio receiver 72. Further, the robot 105 detects the presence or absence of an unauthorized radio wave by means of an unauthorized radio wave detector 17. The robot 105 stops generating the detection sound by means of the detection sound generator 71 after the comparison of the radio signal S1 stored in the radio signal storage 14 and the radio signal S2.

Thus, the robot 105 can generate a detection sound from the loudspeaker by means of the detection sound generator 71 while the radio signal S1 or S2 is being detected by the radio receiver 72 and can detect the unauthorized radio wave even if the attached unauthorized device is an eavesdropping device or spy camera that emits a radio wave upon sensing a sound. Here, since detection sounds from the loudspeaker might entail trouble in some cases, consideration is given so as not to disturb the surroundings.

The influence of own radio waves generated from the loudspeaker of the detection sound generator 71 can be eliminated by the method for removing the own radio signal S0 described in the second embodiment of the present invention, and this method may be adopted if necessary.

As described above, according to the fifth embodiment of the present invention, the robot 105 can detect the presence or absence of an unauthorized radio wave even if an unauthorized device such as an eavesdropping device operative in response to sounds is attached.

It should be noted that the sound generated by the robot is not particularly limited to the above detection sound, and various changes can be made. For example, upon detecting a radio wave or after detecting an unauthorized radio wave, the robot itself may output a small specific sound (maximum length code or the like) peculiar to the robot, demodulate the radio signal in synchronism with frequencies at which a spectrum is found, and detect the presence of an unauthorized radio wave if the radio signal includes this specific sound.

Specifically, the detection sound generator 71 outputs a small specific sound (maximum length code or the like) and the radio receiver 72 receives a radio signal including this specific sound. The radio signal verifier 15 demodulates the radio signal in synchronism with the frequencies at which the spectrum is found, and detects the “presence” of a radio signal having the same characteristics as the specific sound if the specific sound can be demodulated while detecting the “absence” of the radio signal having the same characteristics as the specific sound if the specific sound cannot be demodulated. The unauthorized radio wave detector 17 determines the “presence” of the unauthorized radio wave if the “presence” of the radio signal having the same characteristics is detected by the radio signal verifier 15 as the specific sound while determining the “absence” of the unauthorized radio wave if the “absence” of the radio signal having the same characteristics as the specific sound is detected, and outputs a corresponding detection result. In this case, the eavesdropping or the spy camera can be accurately detected since the specific sound emitted by the robot itself is detected to detect the unauthorized radio wave.

It should be noted that the specific sound is not particularly limited to the above example, and a motor driving sound of the actuator 24, a wheel sound of a locomotion unit 25, a sound of a speed reducer or the like may be used. In such a case, the detection sound generator 71 can be omitted. Further, a microphone for collecting driving sounds of the robot itself may be provided instead of the detection sound generator 71, and the “presence” of the unauthorized radio wave may be determined if the driving sound measured by this microphone and the demodulated specific sound coincide. The above specific sound is preferably demodulated at least between two points and, in this case, the eavesdropping or spy camera can be more accurately detected.

### Sixth Embodiment

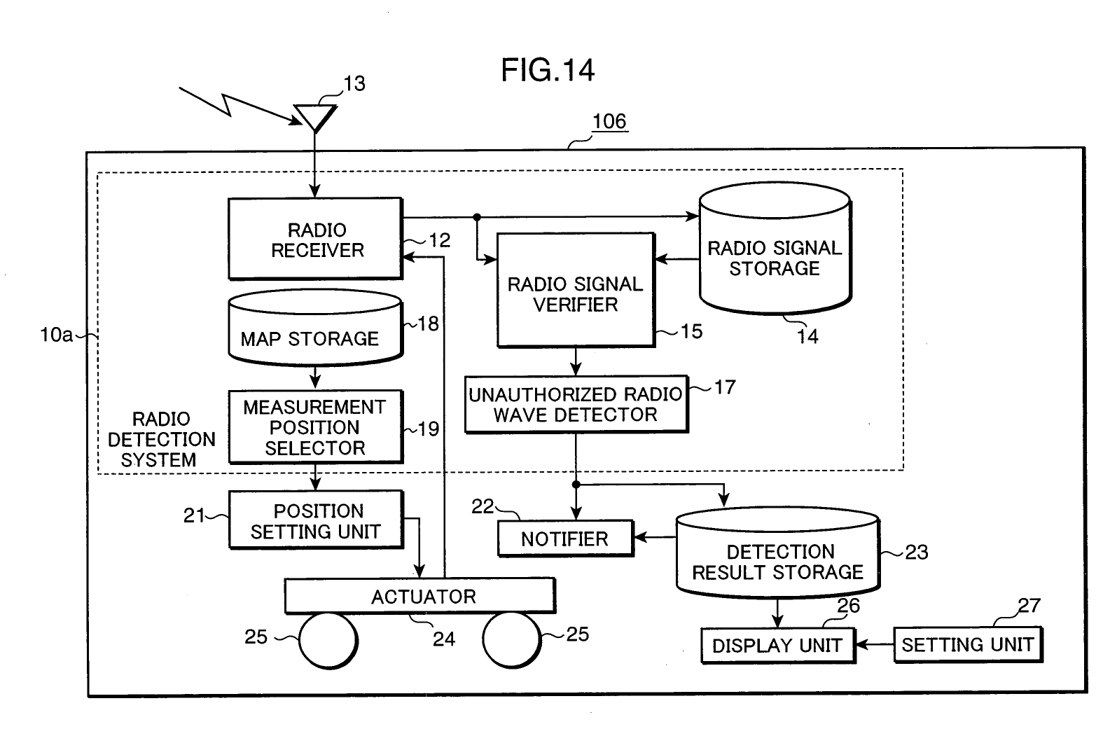

In a sixth embodiment of the present invention, an eavesdropping or spy camera is detected using a position where environmental radio energy, which is environmental noise, is smallest as a measurement position. The construction of the sixth embodiment is described below with reference to FIG. 14. FIG. 14 is a block diagram showing the construction of a robot according to the sixth embodiment.

A robot 106 shown in FIG. 14 differs from the robot 101 of the first embodiment of the present invention in the following points. A radio detection system 10a further includes a map storage 18 for storing a radio intensity map representing the intensities of environmental radio wave at positions in an utilization space (work area) of the robot 106 in correspondence with the respective positions and a measurement position selector 19 for selecting measurement positions where the intensities of the environmental radio waves are small based on the radio intensity map stored in the map storage 18; a position setting unit 21 outputs the measurement positions selected by the measurement position selector 19 as first and second positions P1, P2 to the actuator 24; and an eavesdropping or spy camera is detected using the two positions where the radio intensity is small as measurement positions. Since the process after the two positions where the radio intensity is small are set as the first and second positions P1, P2 is similar to the one in the first embodiment of the present invention, the same operations are not described in detail by identifying the elements performing these operations by the same reference numerals.

For the detection of an unauthorized radio wave, detection accuracy increases (S/N ratio increases) as the intensity of the unauthorized radio wave increases as against the intensity of existing environmental radio waves. In view of this, in this embodiment, the radio intensity map in the utilization space is stored in the map storage 18, the measurement position selector 19 selects two points where the radio intensity is relatively weak, and the robot 106 detects the unauthorized radio wave using these two points as the measurement positions. It should be noted that the measurement positions are not particularly limited to two points and measurement may be conducted using three or more points where the radio intensity is small.

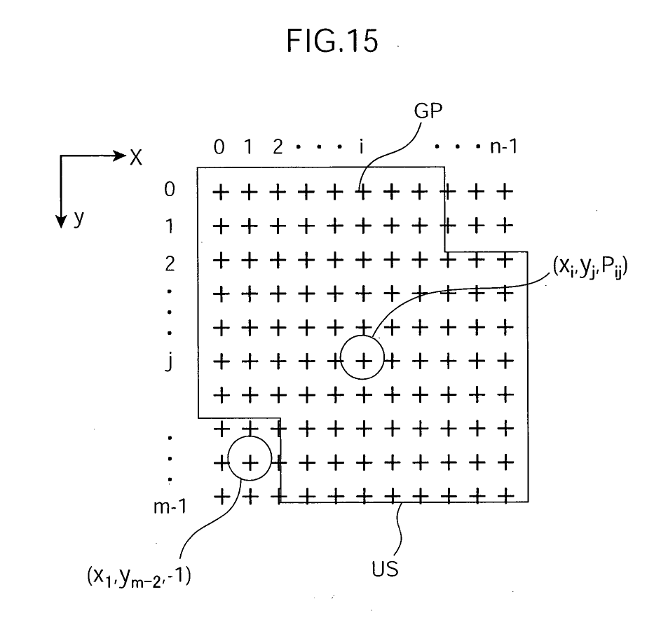

The radio intensity map is prepared by measuring the radio intensity at each position while a robot service provider is remote-controlling the robot in the utilization space, and stored in the map storage 18 beforehand. FIG. 15 is a diagram showing an example of the radio intensity map.

First, grid points GP are allotted at regular intervals in a utilization space US of the robot 106, and a pair of coordinates (xᵢ, yⱼ) and a radio intensity Pᵢⱼ (summation or square sum of spectral intensities at the respective frequencies) at the grip point GP is allotted to each grid point GP as expressed in the following equation.

PMap={(xᵢ,yⱼ,Pᵢⱼ)|i=0, . . . ,n−1,j=0, . . . ,m−1}

−1 is allotted to points not present in the utilization space US. For example, (x₁, yₘ₋₂, −1) is allotted to coordinates (x₁, yₘ₋₂) shown in FIG. 15. Here, intervals between the grid points GP may be arbitrary set, for example, to 10 cm, 20 cm, 50 cm beforehand, but grid points may be allotted to arbitrary points in the utilization space without being particularly limited to this example.

It should be noted that, as described in the second embodiment, radio waves may be measured at specified time intervals during the usual travel of the robot and radio intensities when no unauthorized radio wave was measured may be stored in the radio intensity map in correspondence with positions at the respective times.

For example, if a plurality of robots are deployed in a building such as an apartment house or airport and each provided with a transceiver unit as in the fourth embodiment and an administration system administering the robots is constructed to be communicable with the respective robots, the respective robots may measure radio intensities and transmit them to the administration system while patrolling specified routes. In this case, the administration system can compile the radio intensities measured by the respective robots into a radio intensity map and inform this radio intensity map and/or places selected from the radio intensity map where the radio intensity is weak. Further, the respective robots can transmit detected radio signals to the administration system, and the administration system can detect the presence or absence of the unauthorized radio wave and transmit the detection result to the respective robots.

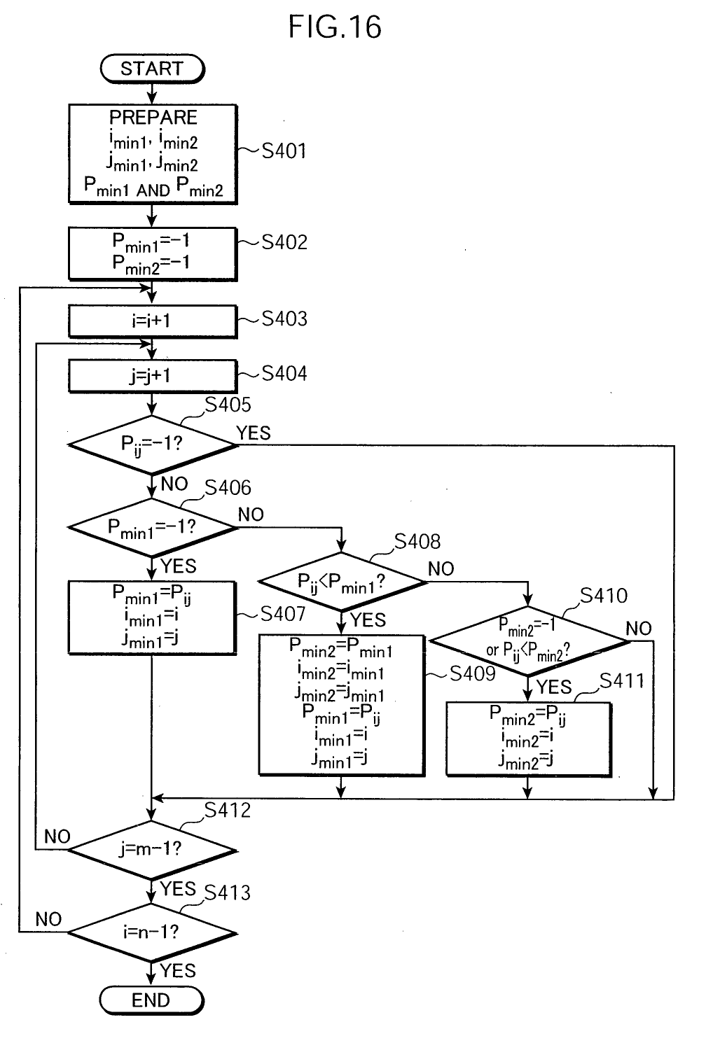

Next, a method for selecting the two points used for the detection of the unauthorized radio wave from the above radio intensity map is described with reference to a flow chart of FIG. 16. FIG. 16 is a flow chart showing a measurement position selection processing by the measurement position selector 19 shown in FIG. 14. It is assumed that the radio intensity map is already obtained and stored in the map storage 18.

First, the measurement position selector 19 prepares iₘᵢₙ₁, iₘᵢₙ₂, jₘᵢₙ₁, jₘᵢₙ₂, Pₘᵢₙ₁, and Pₘᵢₙ₂ in a memory space (S401) and initializes Pₘᵢₙ₁ and Pₘᵢₙ₂ to −1 and sets i and j to 0 (Step S402). Subsequently, the measurement position selector 19 first proceeds to a next pair of i, j (Steps S412, S413) if Pᵢⱼ is −1 (Step S405) while successively incrementing i and j by one (Step S403, S404).

On the other hand, unless Pᵢⱼ is −1 (Step S406), the measurement position selector 19 substitutes Pᵢⱼ, i, j respectively for Pₘᵢₙ₁, iₘᵢₙ₁, Jₘᵢₙ₁ (Step S407) and proceeds to a next pair of i, j (Steps S412, S413) until i becomes n−1 and j becomes m−1.

If Pₘᵢₙ₁ is not −1 and Pᵢⱼ is smaller than Pₘᵢₙ₁ (Step S408), the measurement position selector 19 substitutes Pₘᵢₙ₁, iₘᵢₙ₁, jₘᵢₙ₁ respectively for Pₘᵢₙ₂, iₘᵢₙ₂, iₘᵢₙ₂ and substitutes Pᵢⱼ, i, j respectively for Pₘᵢₙ₁, iₘᵢₙ₁, jₘᵢₙ₁ (Step S409) and proceeds to a next pair of i, j (Steps S412, S413) until i becomes n−1 and j becomes m−1.

On the other hand, unless Pᵢⱼ is smaller than Pₘᵢₙ₁ in Step S408, the measurement position selector 19 substitutes Pᵢⱼ, i, j respectively for Pₘᵢₙ₂, iₘᵢₙ₂, iₘᵢₙ₂ if Pₘᵢₙ₂ is −1 or Pᵢⱼ is smaller than Pₘᵢₙ₂ (Step S410) and proceeds to a next pair of i, j (Steps S412, S413) until i becomes n−1 and j becomes m−1.

By the above processing, the measurement position selector 19 can select two points in the utilization space US where the radio intensity is weak, and the position setting unit 21 sets these two points (xₘᵢₙ₁, yₘᵢₙ₁), (xₘᵢₙ₂, yₘᵢₙ₂) as the first and second positions P1, P2. Thereafter, the robot 106 compares spectral intensities (intensities at each frequency) at the two points using these two points (xₘᵢₙ₁, yₘᵢₙ₁), (xₘᵢₙ₂, yₘᵢₙ₂) as the first and second positions P1, P2 to detect the presence or absence of the unauthorized radio wave similar to the first embodiment.

Since the robot 106 can autonomously search for a place where the total energy of the environmental radio waves is smallest and detect the presence or absence of the unauthorized radio wave by selecting the two points where the radio intensity is weakest, the S/N ratio of the processing of detecting radio waves for eavesdropping and secret filming can be improved by minimizing the environmental noise, wherefore unauthorized radio waves emitted by unauthorized devices can be accurately detected.

Although the place where the total energy of the environmental radio waves is smallest is autonomously searched in this embodiment, the presence or absence of the unauthorized radio wave may be detected in the center of a room since environmental radio waves are easily reflected near walls and furniture. Further, a known source of transmission (e.g. access point of a wireless LAN) may be stored in the radio intensity map and positions distant from this source of transmission may be selected as measurement positions.

Although the spectral intensities (levels of the respective spectra) are stored in the form of the radio intensity map, the distribution of spectrum levels may be stored and points where this distribution is equal to or below a specified threshold value may be selected as measurement positions without being particularly limited to the above example. Further, measurement positions may be selected in consideration of the level distribution dependent on hours and the distribution changing cycle.

### Seventh Embodiment

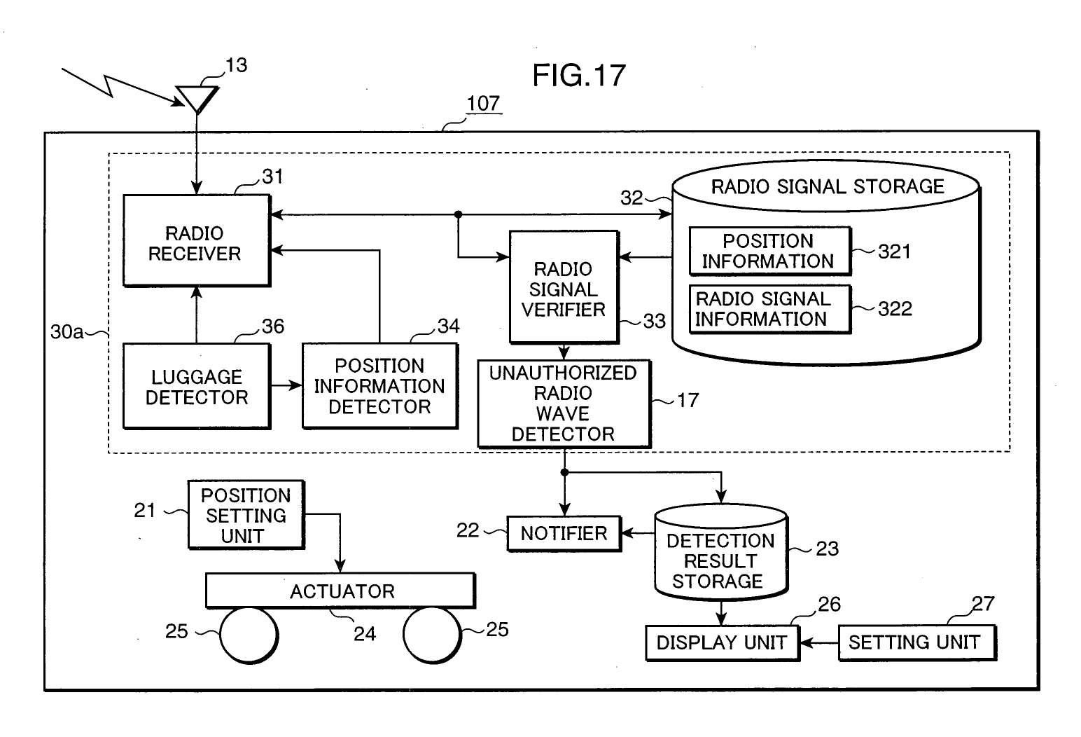

In a seventh embodiment of the present invention, an eavesdropping device or spy camera attached to luggage is detected when a robot transports the luggage. The construction of the seventh embodiment is described below with reference to FIG. 17. FIG. 17 is a block diagram showing the construction of a robot according to the seventh embodiment. Elements similar to those of the second embodiment of the present invention are not described in detail below by being identified by the same reference numerals.

As shown in FIG. 17, a robot 107 of the seventh embodiment of the present invention differs from the robot 102 of the second embodiment of the present invention in that a radio detection system 30a includes a luggage detector 36 for generating a trigger signal upon detecting the placement of luggage instead of the trigger signal generator 35.

The luggage detector 36 detects the placement of luggage on a luggage rack of the robot 107 using a weight sensor or contact sensor and generates a trigger signal. A luggage detection method is not particularly limited to the above example. For example, the robot 107 may be equipped with a luggage box and a trigger signal may be generated upon detecting opening and closing movements of a door of the luggage box.

When luggage is placed on the luggage rack of the robot 107, the luggage detector 36 detects the placement of the luggage on the robot 107 and outputs a trigger signal to a radio receiver 31 and a position information detector 34. Thereafter, similar to the operation in the second embodiment, a plurality of pieces of radio signal information and a plurality of pieces of position information are detected to detect an eavesdropping device or spy camera attached to the luggage. In the above detecting operation, radio signals are verified if a specified number of pieces of radio signal information are stored in the radio signal storage 32 (Step S206) in the second embodiment, but the operation in Step S206 may be omitted and radio signals may be verified every time luggage is placed.

According to the seventh embodiment of the present invention, the robot 107 can detect the presence or absence of a radio signal having the same characteristics when the luggage is placed by the above construction, wherefore the eavesdropping device or spy camera can be accurately detected even if being attached not to the robot 107 itself, but to the luggage.

A warning is given to the outside when the attachment of the eavesdropping device or spy camera to the luggage is determined in this embodiment similar to the second embodiment. Instead of this or in addition to this, if the attachment of the eavesdropping device or spy camera to the luggage is confirmed by a changed radio state after the luggage is left, a first warning may be notified to a computer or the like of a user at a delivery end at the time of the delivery of the luggage and a second warning may be notified to the computer or the like of the user at the delivery end upon confirming a radio state after the delivery.

In this embodiment, similar to the second embodiment, the radio receiver 31 stores the radio signal information and the position information in the radio signal storage 32 while associating them with each other if a difference between position information obtained from the position information detector 34 and position information 321 stored in the radio signal storage 32 is larger than a specified distance difference, thereby storing the radio signal information at mutually different positions in the radio signal storage 32 in synchronism with the generation timings of the trigger signals. However, various changes can be made without being particularly limited to this example.

For example, if the difference between the position information obtained from the position information detector 34 and the position information 321 stored in the radio signal storage 32 is equal to or smaller than the specified distance difference, the radio receiver 31 may set the position of a destination of the robot 107 in the position setting unit 21 such that a difference between the position of the robot 107 and the position represented by the position information 321 stored in the radio signal storage 32 becomes larger than the specified distance difference. At this time, the radio receiver 31 may detect a radio wave to detect a radio signal and store the detected radio signal information and the position information in the radio signal storage 32 while associating them with each other after the position setting unit 21 outputs the position information of the set destination to the actuator 24 to move the robot 107. In this case as well, the presence or absence of a radio signal having the same characteristics can be detected at a plurality of mutually different positions, wherefore the eavesdropping device or spy camera attached to the luggage can be accurately detected.

Further, by omitting the position information detector 34, the radio receiver 31 may receive a radio wave to detect a radio signal in synchronism with the generation timing of the trigger signal, i.e. a luggage detecting timing regardless of the position of the robot 107 and store the detected radio signal in the radio signal storage 32. At this time, the radio signal verifier 33 compares a radio signal detected at the generation timing of the present trigger signal and a radio signal detected at the generation timing of one previous (or earlier) trigger signal and stored in the radio signal storage 32 to detect the presence or absence of a radio signal having the same characteristics. In this case, the detected radio signal can be verified to detect an eavesdropping device or spy camera attached to luggage every time luggage is placed.

Although the detection of the unauthorized radio wave is triggered by the placement of the luggage in this embodiment, the attachment of the eavesdropping device or spy camera to the luggage may be determined by comparing a radio state before the luggage is placed and the one after the luggage is placed without being particularly limited to this example.

Although the radio waves of the eavesdropping device or spy camera are detected between two different points in the above respective embodiments, the present invention is not particularly limited to this example. When the presence or absence of a radio wave of an eavesdropping device or spy camera is detected and the radio wave of the eavesdropping device or spy camera is detected, radio spectra detected by moving between the two points may be compared and the attachment of the eavesdropping device or spy camera to the robot itself or the luggage may be determined if no (or little) change in characteristics is caused by the position transfer.

Although a warning is given after the detection of the eavesdropping device or spy camera in the above respective embodiments, the process after the detection is not particularly limited to this example. The robot may autonomously enter a shielding chamber to shield radio waves of the eavesdropping device or spy camera or may autonomously emit an interfering wave in the same frequency band as the radio wave of the eavesdropping device or spy camera.

The radio detection systems or robots according to the first to seventh embodiments of the present invention may be implemented by hardware using an integrated circuit or software using a CPU or the like.

First, in the case of implementing the radio detection processing by hardware, each function in the embodiments of the present invention may be individually incorporated into an integrated circuit in the form of one chip or part or all of the functions may be incorporated into an integrated circuit in the form of one chip.

Further, the integrated circuit may be realized by a dedicated circuit or general-purpose processor. For example, after producing a semiconductor chip, a programmable FPGA (field programmable gate array) or a reconfigurable processor in which the connection and settings of cells in an integrated circuit are reconfigurable may be used.

Further, with the possible advent of integrated circuit technology by the progress in semiconductor technology or another technology derived from semiconductor technology, the function block may be, of course, integrated using such technology. For example, the application of a biocomputer, etc. is possible by the progress of biotechnology.

### Eighth Embodiment

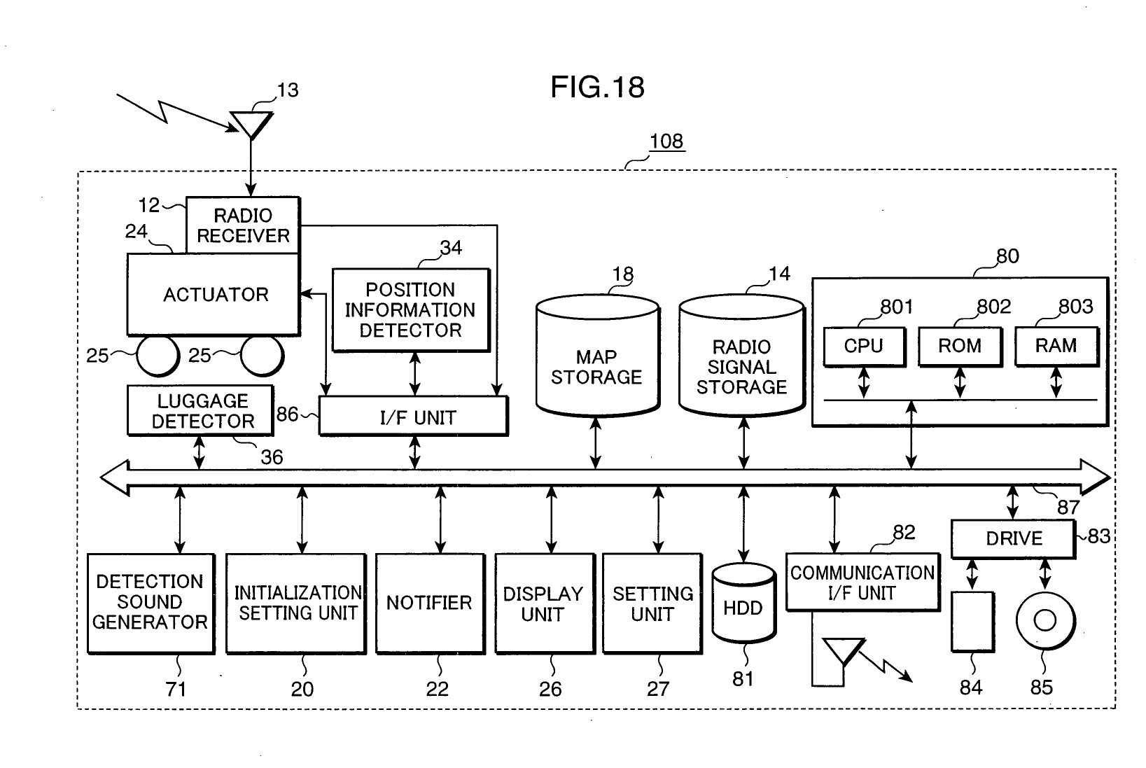

In an eighth embodiment of the present invention, the above radio detection processing is carried out by software. The construction of the eighth embodiment is described below with reference to FIG. 18. FIG. 18 is a block diagram showing the construction of a computer system according to the eighth embodiment of the present invention. Elements similar to those of the first to seventh embodiments of the present invention are not described in detail below by being identified by the same reference numerals.

In FIG. 18, a computer system 108 is provided with a locomotion unit 25 for a movement to a set position, an actuator 24 for driving the locomotion unit 25, an initialization setting unit 20 for setting an initialization operation, a radio receiver 12 for receiving a radio wave by means of an antenna 13 to detect a radio signal, a position information detector 34 for detecting position information, an I/F unit 86 for the input and output of signals, a radio signal storage 14 for storing radio signals, a map storage 18 for storing a radio intensity map, a notifier 22 for giving a warning to the outside, a display unit 26 for displaying detection results, a setting unit 27 for setting contents to be displayed, a luggage detector 36 for generating a trigger signal upon detecting the placement of luggage, a detection sound generator 71 for generating a sound when a radio signal is detected, an HDD 81 for storing detection results, a communication I/F unit 82 for the communication with the outside, a drive 83 for the input and output of information in and from an information recording medium, and a controller 80.

The controller 80 is for controlling the operation of a robot and performing a radio detection processing, and functions as the radio signal verifier 15, the unauthorized radio wave detector 17, the measurement position selector 19, the position setting unit 21, the trigger signal generator 35, the stop controller 28, etc. by controlling the actuator 24 and the locomotion unit 25, obtaining radio signals from the radio receiver 12, obtaining position information from the position information detector 34, transmitting and receiving internal signals, performing a robot operation processing such as an unauthorized radio wave detection processing, and performing a signal processing by a specified control program and a radio detection processing program.

The controller 80 includes a CPU 801 for processing commands of various programs, a read-only memory 802 (hereinafter, “ROM 802”) storing the radio detection processing program and the like, and a random access memory 803 (hereinafter, “RAM 803”) for temporarily saving data.

The CPU 801 performs various processings in accordance with a program stored in the ROM 802, a program stored in the HDD 81 or a program stored in the RAM 803. Further, the CPU 801 temporarily saves data necessary for the processings of the respective units in the RAM 803.

The drive 83 obtains storage information such as the radio detection processing program stored in the recording medium by suitably connecting a computer-readable recording medium. The computer-readable recording medium is, for example, a disk 85 such as a magnetic disk, a magneto optical disk or an optical disk or a memory card 84 such as a semiconductor memory. Further, the drive 83 writes storage information generated by the computer system 108 in the recording medium. Components of radio signals of unauthorized radio waves emitted by unauthorized devices and the like, information on positions where unauthorized radio waves were detected, and history information on the detection of unauthorized radio waves may be stored as this storage information. Further, information on unauthorized radio waves may be stored in the disk 85 or the memory card 84 to provide the computer system 108 with such information.

The HDD 81 may include a magnetic memory or the like and store software that is a group of programs necessary for the radio detection processing. Programs constituting the software for the radio detection processing may be incorporated into a computer using dedicated hardware or may be provided by being incorporated into the ROM 802 or the HDD 81.

Separately from the computer system 108, the programs may be obtained from a recording medium storing these programs. For example, the disk 85 or the memory card 84 may be suitably connected with the drive 83 and the computer program read therefrom may be installed in the HDD 81 if necessary.

Further, the wireless communication I/F unit 82 may be provided for the connection with a network to obtain programs via the network, and the obtained programs may be installed in the HDD 81 if necessary. Thus, the computer system 108 is remote-controllable by means of the communication I/F unit 82. Further, the control program and the radio detection processing program may be downloaded.

It should be noted that the radio detection system and the radio detection method according to the present invention are also applicable to remote-controllable toys, autonomously mobile toys, game apparatuses, handheld terminals, mobile phones, notebook personal computers, etc. and fulfill effects similar to those of the first to seventh embodiments of the present invention.

The present invention exemplified by the above respective embodiments is summarized as follows. Specifically, a robot according to the present invention comprises a locomotion unit for movements to a plurality of positions; a radio receiver for receiving radio waves at a plurality of mutually different positions to detect a plurality of radio signals; a radio signal verifier for detecting the presence or absence of a radio signal having the same characteristics by comparing the plurality of detected radio signals; an unauthorized radio wave detector for detecting the presence of an unauthorized radio wave if the radio signal having the same characteristics is present; and a notifier for giving notification when the unauthorized radio wave is detected.

According to this construction, unauthorized radio waves emitted by an eavesdropping device, spy camera or like device moving together with the robot main body can be detected and notification can be made upon such detection since the radio signal having the same characteristics can be detected by comparing the radio signals detected at the plurality of mutually different positions.

It is preferable that the above robot further comprises a trigger signal generator for generating trigger signals at specified time intervals and a position detector for detecting a plurality of pieces of position information at mutually different timings in accordance with the trigger signals; and that the radio receiver detects the plurality of radio signals based on the plurality of pieces of position information.

In this case, the plurality of pieces of position information can be obtained at the specified time intervals, wherefore even robots moved or carried around by people or the like without being able to autonomously move can detect positions and compare a plurality of radio signals detected at mutually different positions.

It is preferable that the above robot further comprises an own radio signal storage for storing an own radio signal; and that the radio signal verifier compares radio signals obtained by removing the own radio signal stored in the own radio signal storage from the plurality of radio signals.

In this case, unauthorized radio waves of a wireless eavesdropping device, spy camera or like device attached to the robot main body can be more easily detected since the plurality of radio signals having the own radio signal removed therefrom can be compared.

It is preferable that the above robot further comprises a stop controller for controlling whether or not to stop a specified function; and that the stop controller stops the specified function while the radio receiver is detecting the plurality of radio signals.

In this case, radio waves emitted by the robot itself can be reduced and unauthorized radio waves of a wireless eavesdropping device, spy camera or like device can be more easily detected since the specified function of the robot is stopped while the plurality of radio signals are being detected.

It is preferable that the above robot further comprises a detection sound generator for generating a sound; and that the detection sound generator generates sounds while the radio receiver is detecting the plurality of radio signals.

In this case, eavesdropping devices and the like that emit radio waves in response to sounds can also be activated in addition to eavesdropping devices that constantly emit eavesdropping waves since sounds are generated while the plurality of radio signals are being detected. Thus, unauthorized radio waves can be better detected.

It is preferable that the detection sound generator generates a specific sound; that the radio signal verifier demodulates a detected radio signal and detects the presence or absence of a radio signal having the same characteristics as the specific sound; and that the unauthorized radio wave detector detects the presence of an unauthorized radio wave if the radio signal having the same characteristics as the specific sound is present.

In this case, an eavesdropping device or spy camera can be accurately detected since the unauthorized radio wave is detected by detecting the specific sound emitted by the robot itself.

The above robot preferably further comprises a detection result storage for storing a detection result of the radio signal verifier on the radio signal having the same characteristics; a setting unit for the settings for the display of the detection result; and a display unit for displaying the detection result stored in the detection result storage based on the settings.

In this case, the presence or absence of an unauthorized radio wave emitted by a wireless eavesdropping device, spy camera or like device can be easily grasped and the detection result can be utilized as history information on the unauthorized use of the robot since the detection result on the radio signal having the same characteristics is displayed based on the settings by a user.

It is preferable that the above robot further comprises a map storage for storing a radio intensity map representing the intensities of radio waves at positions in a utilization space of the robot in correspondence with the respective positions and a measurement position selector for selecting measurement positions where the intensity of environmental radio waves is small by referring to the radio intensity map; and that the radio receiver receives radio waves at the measurement positions to detect a plurality of radio signals.

In this case, a place where the total energy of the environmental radio waves is smallest can be autonomously searched for and the presence or absence of the unauthorized radio wave can be detected by selecting two points where the radio intensity is weakest. Thus, the S/N ratio of the detection of radio waves for eavesdropping and secret filming can be improved by minimizing environmental noise, wherefore unauthorized radio waves can be accurately detected.

It is preferable that the above robot further comprises a luggage detector for generating a trigger signal upon detecting the placement of luggage on the robot and a position detector for detecting the present position information in accordance with the trigger signal; and that the radio receiver detects the plurality of radio signals based on a plurality of pieces of position information detected by the position detector.

In this case, an eavesdropping device or spy camera can be accurately detected even if being attached not to the robot itself, but to the luggage since the presence or absence of a radio signal having the same characteristics can be detected when the luggage is placed.

Another robot according to the present invention comprises a locomotion unit for movements to a plurality of positions; a luggage detector for generating a trigger signal upon detecting the placement of luggage on the robot; a radio receiver for receiving radio waves in accordance with the trigger signal to detect a plurality of radio signals; a radio signal verifier for detecting the presence or absence of a radio signal having the same characteristics by comparing the plurality of detected radio signals; an unauthorized radio wave detector for detecting the presence of an unauthorized radio wave when the radio signal having the same characteristics is present; and a notifier for giving notification when the unauthorized radio wave is detected.

According to this construction, an eavesdropping device or spy camera can be detected and notification can be made upon such detection even if the eavesdropping device or spy camera is attached not to the robot itself, but to the luggage since the radio signal having the same characteristics can be detected by comparing the radio signals detected when the luggage was placed.

A radio detection system according to the present invention comprises a radio receiver for receiving radio waves at a plurality of mutually different positions to detect a plurality of radio signals; a radio signal verifier for detecting the presence or absence of a radio signal having the same characteristics by comparing the plurality of detected radio signals; and an unauthorized radio wave detector for detecting the presence of an unauthorized radio wave when the radio signal having the same characteristics is present.

According to this construction, unauthorized radio waves emitted by an eavesdropping device, spy camera or like device moving together with an apparatus main body can be detected since the radio signal having the same characteristics can be detected by comparing the radio signals detected at the mutually different positions.

It is preferable that the above radio detection system further comprises a trigger signal generator for generating trigger signals at specified time intervals and a position detector for detecting a plurality of pieces of position information at mutually different timings in accordance with the trigger signals; and that the radio receiver detects the plurality of radio signals based on the plurality of pieces of position information.

In this case, the radio detection system can detect positions and compare a plurality of radio signals detected at mutually different positions even if being attached to an apparatus moved or carried around by a person since a plurality of pieces of position information can be obtained at the specified time intervals.

A radio detection method according to the present invention comprises a radio reception step of receiving radio waves at a plurality of mutually different positions to detect a plurality of radio signals; a radio signal verification step of detecting the presence or absence of a radio signal having the same characteristics by comparing the plurality of detected radio signals; and an unauthorized radio wave detection step of detecting the presence of an unauthorized radio wave when the radio signal having the same characteristics is present.

According to this method, unauthorized radio waves emitted by an eavesdropping device, spy camera or like device moving together with an apparatus main body can be detected since the radio signal having the same characteristics can be detected by comparing the radio signals detected at the mutually different positions.

A recording medium according to the present invention is a computer-readable recording medium storing a radio detection processing program, wherein the radio detection processing program causes a computer to function as a radio signal verifier for detecting the presence or absence of a radio signal having the same characteristics by comparing a plurality of radio signals detected at mutually different positions; and an unauthorized radio wave detector for detecting the presence of an unauthorized radio wave when the radio signal having the same characteristics is present.

According to the radio detection processing program stored in this recording medium, unauthorized radio waves emitted by an eavesdropping device, spy camera or like device moving together with an apparatus main body can be detected since the radio signal having the same characteristics can be detected by comparing the radio signals detected at the mutually different positions.

The present invention enables the detection of radio waves emitted by a wireless eavesdropping device or spy camera attached to a mobile apparatus main body and is useful for radio detection systems, radio detection methods and robots.

This application is based on Japanese patent application serial No. 2006-136048, filed in Japan Patent Office on May 16, 2006, the contents of which are hereby incorporated by reference.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds are therefore intended to embraced by the claims.

What is claimed is:

1. A robot, comprising:
a locomotion unit for movements to a plurality of positions;
a radio receiver for receiving radio waves at a plurality of mutually different positions to detect a plurality of radio signals;
a radio signal verifier for detecting the presence or absence of a radio signal having the same characteristics by comparing the plurality of detected radio signals;
an unauthorized radio wave detector for detecting the presence of an unauthorized radio wave if the radio signal having the same characteristics is present; and
a notifier for giving notification when the unauthorized radio wave is detected.

2. A robot according to claim 1, further comprising:
a trigger signal generator for generating trigger signals at specified time intervals; and
a position detector for detecting a plurality of pieces of position information at mutually different timings in accordance with the trigger signals;
wherein the radio receiver detects the plurality of radio signals based on the plurality of pieces of position information.

3. A robot according to claim 1, further comprising an own radio signal storage for storing an own radio signal, wherein the radio signal verifier compares radio signals obtained by removing the own radio signal stored in the own radio signal storage from the plurality of radio signals.

4. A robot according to claim 1, further comprising a stop controller for controlling whether or not to stop a specified function, wherein the stop controller stops the specified function while the radio receiver is detecting the plurality of radio signals.

5. A robot according to claim 1, further comprising a detection sound generator for generating a sound; wherein the detection sound generator generates sounds while the radio receiver is detecting the plurality of radio signals.

6. A robot according to claim 5, wherein;
the detection sound generator generates a specific sound;
the radio signal verifier demodulates a detected radio signal and detects the presence or absence of a radio signal having the same characteristics as the specific sound; and
the unauthorized radio wave detector detects the presence of an unauthorized radio wave if the radio signal having the same characteristics as the specific sound is present.

7. A robot according to claim 1, further comprising:
a detection result storage for storing a detection result of the radio signal verifier on the radio signal having the same characteristics;
a setting unit for the settings for the display of the detection result; and
a display unit for displaying the detection result stored in the detection result storage based on the settings.

8. A robot according to claim 1, further comprising:
a map storage for storing a radio intensity map representing the intensities of radio waves at positions in a utilization space of the robot in correspondence with the respective positions; and
a measurement position selector for selecting measurement positions where the intensity of environmental radio waves is small by referring to the radio intensity map;
wherein the radio receiver receives radio waves at the measurement positions to detect a plurality of radio signals.

9. A robot according to claim 1, further comprising:
a luggage detector for generating a trigger signal upon detecting the placement of luggage on the robot; and
a position detector for detecting the present position information in accordance with the trigger signal,
wherein the radio receiver detects the plurality of radio signals based on a plurality of pieces of position information detected by the position detector.

10. A robot, comprising:
a locomotion unit for movements to a plurality of positions;
a luggage detector for generating a trigger signal upon detecting the placement of luggage on the robot;
a radio receiver for receiving radio waves in accordance with the trigger signal to detect a plurality of radio signals;
a radio signal verifier for detecting the presence or absence of a radio signal having the same characteristics by comparing the plurality of detected radio signals;
an unauthorized radio wave detector for detecting the presence of an unauthorized radio wave when the radio signal having the same characteristics is present; and
a notifier for giving notification when the unauthorized radio wave is detected.

11. A radio detection system, comprising:
a radio receiver for receiving radio waves at a plurality of mutually different positions to detect a plurality of radio signals;
a radio signal verifier for detecting the presence or absence of a radio signal having the same characteristics by comparing the plurality of detected radio signals; and
an unauthorized radio wave detector for detecting the presence of an unauthorized radio wave when the radio signal having the same characteristics is present.

12. A radio detection system according to claim 11, further comprising:
a trigger signal generator for generating trigger signals at specified time intervals; and
a position detector for detecting a plurality of pieces of position information at mutually different timings in accordance with the trigger signals,
wherein the radio receiver detects the plurality of radio signals based on the plurality of pieces of position information.

13. A radio detection method, comprising:
a radio reception step of receiving radio waves at a plurality of mutually different positions to detect a plurality of radio signals;
a radio signal verification step of detecting the presence or absence of a radio signal having the same characteristics by comparing the plurality of detected radio signals; and
an unauthorized radio wave detection step of detecting the presence of an unauthorized radio wave when the radio signal having the same characteristics is present.

14. A computer-readable recording medium storing a radio detection processing program, the radio detection processing program causing a computer to function as:
a radio signal verifier for detecting the presence or absence of a radio signal having the same characteristics by comparing a plurality of radio signals detected at mutually different positions; and
an unauthorized radio wave detector for detecting the presence of an unauthorized radio wave when the radio signal having the same characteristics is present.
